(19) United States
(12) Patent Application Publication
(10) Pub. No.: US 2017/0034449 A1
(43) Pub. Date: Feb. 2, 2017

(54) MOBILE TERMINAL AND METHOD FOR CONTROLLING SAME

(71) Applicant: LG ELECTRONICS INC., Seoul (KR)

(72) Inventors: Hyomin EUM, Seoul (KR); Seongeun KIM, Seoul (KR); Yonjae KANG, Seoul (KR); Chorok SHIN, Seoul (KR); Eunyoung NOH, Seoul (KR)

(73) Assignee: LG ELECTRONICS INC., Seoul (KR)

(21) Appl. No.: 15/085,604

(22) Filed: Mar. 30, 2016

(30) Foreign Application Priority Data
Jul. 28, 2015 (KR) 10-2015-0106792

(51) Int. Cl. H04N 5/265; H04N 5/232; G06F 3/0488; H04N 5/247

(52) U.S. Cl. CPC H04N 5/265; H04N 5/247; H04N 5/23229; H04N 5/23293; G06F 3/0488; H04N 5/23216

(57) ABSTRACT

There are provided a mobile terminal providing an image capture function and a method for controlling the same. The mobile terminal includes a first camera configured to capture an image at a first angle of view, a second camera configured to capture an image at a second angle of view different from the first angle of view, and a controller configured to capture a first image received from the first camera and a second image received from the second camera, wherein the controller may process the first and second images by associating the first and second images.

### CROSS-REFERENCE TO RELATED APPLICATION

Pursuant to 35 U.S.C. §119(a), this application claims the benefit of earlier filing date and right of priority to Korean Application No. 10-2015-0106792, filed on Jul. 28, 2015, the contents of which is incorporated by reference herein in its entirety.

### BACKGROUND OF THE INVENTION

1. Field of the Invention

The present disclosure relates to a mobile terminal providing an image capture function and a method for controlling the same.

2. Background of the Invention

Terminals may be generally classified as mobile/portable terminals or stationary terminals according to their mobility. Mobile terminals may also be classified as handheld terminals or vehicle mounted terminals according to whether or not a user can directly carry the terminal.

Mobile terminals have become increasingly more functional. Examples of such functions include data and voice communications, capturing images and video via a camera, recording audio, playing music files via a speaker system, and displaying images and video on a display. More recently, mobile terminals have been configured to receive broadcast and multicast signals which permit viewing of content such as videos and television programs.

As functions of the terminal become more diversified, the terminal can support more complicated functions such as capturing images or video, reproducing music or video files, playing games, receiving broadcast signals, and the like. By comprehensively and collectively implementing such functions, the mobile terminal may be embodied in the form of a multimedia player or a device.

Efforts are ongoing to support and increase the functionality of mobile terminals. Such efforts include software and hardware improvements, as well as changes and improvements in the structural components.

Recently, user demand for capturing images through mobile terminals equipped with a camera has increased. Structural parts and/or software parts related to cameras have been variously developed. As part of such development, mobile terminals equipped with two or more cameras having different angles of view have been developed. Thus, necessity to develop various methods for capturing images using two or more cameras has emerged.

### SUMMARY OF THE INVENTION

Therefore, an aspect of the detailed description is to provide a method for capturing an image using two or more cameras having different angles of view.

To achieve these and other advantages and in accordance with the purpose of this specification, as embodied and broadly described herein, a mobile terminal configured to capture an image may include: a first camera configured to capture an image at a first angle of view; a second camera configured to capture an image at a second angle of view different from the first angle of view; and a control unit configured to capture a first image received from the first camera and a second image received from the second camera, wherein the control unit may process the first and second images by associating the first and second images.

In an embodiment, the control unit may detect a partial image corresponding to the first image from the second image, and replace the detected partial image with the first image to generate a synthesized synthetic image.

In an embodiment, the first camera and the second camera may have the same image capture direction, and the control unit may capture images simultaneously in the same image capture direction through the first camera and the second camera.

In an embodiment, the control unit may generate at least one of the simultaneously captured images, as a moving image.

In an embodiment, the control unit may sequentially capture the images received through the first camera and the second camera.

In an embodiment, the mobile terminal may further include: a display unit configured to display a preview image of the first image received from the first camera and a preview image of the second image received from the second camera, wherein the control unit may detect a preview image corresponding to the first image from the preview image of the second image, and display the preview image of the first image corresponding to the detected preview image on the second image in an overlapping manner.

In an embodiment, the control unit may display a graphic object visually distinguishing between the first image and the second image in a boundary region of the preview image of the first image and the preview image of the second image.

In an embodiment, when a preset type of touch is applied to the display unit, the control unit may control the first camera or the second camera such that the preview image of the first image or the preview image of the second image is zoomed in or zoomed out.

In an embodiment, the control unit may control the first camera or the second camera such that the first image and the second image have different visual effects.

In an embodiment, when an image capture request for capturing an image is received from a user, the control unit may simultaneously capture the first image and the second image displayed on the display unit, and synthesize the first image and the second image such that the first image overlaps the second image to generate a synthetic image.

In an embodiment, the mobile terminal may further include: a display unit configured to include a first region displaying a preview image of the first image received from the camera and a second region displaying a preview image of the second region received from the second camera, wherein when a touch is applied to any one of the first region and the second region, the control unit may capture the preview image displayed in the any one region, as video.

In an embodiment, while the first image displayed in the first region is being captured as video on the basis of the touch applied to the first region, when a touch applied to the second region is sensed, the control unit may capture the second image displayed in the second region, as video.

In an embodiment, when a touch applied to the second region is sensed, the control unit may stop capturing the video of the first image.

In an embodiment, the control unit may synthesize the first image captured as video and the second image captured as video to generate a synthetic image.

In an embodiment, the first camera and the second camera have the same image capture direction, and the mobile terminal may further include a third camera having an image capture direction different from those of the first camera and the second camera, wherein the control unit may capture still images through the first camera and the second camera, and capture video through the third camera.

To achieve these and other advantages and in accordance with the purpose of this specification, as embodied and broadly described herein, a method for controlling a mobile terminal having a plurality of cameras provided to capture images at different angles of view, includes: capturing a first image by a first camera configured to capture an image at a first angle of view; capturing a second image by a camera configured to capture an image at a second angle of view different from the first angle of view; and processing the first image and the second image by associating the first image and the second image.

In an embodiment, in the processing of the first image and the second image by associating the first image and the second image, a synthetic image may be generated by synthesizing the first image and the second image.

In an embodiment, the synthetic image may be a synthetic image generated by replacing a partial image of the second image, which the same as the first image, with the first image.

In an embodiment, the method may further include: displaying the first image and the second image on the display unit, wherein when a preset type of touch is applied to a region in which the first image or the second image is displayed, the first image or the second image may be zoomed in or zoomed out.

In an embodiment, the first image may be displayed on a partial image corresponding to the same image in the second image as the first image in an overlapping manner.

Further scope of applicability of the present application will become more apparent from the detailed description given hereinafter. However, it should be understood that the detailed description and specific examples, while indicating preferred embodiments of the invention, are given by way of illustration only, since various changes and modifications within the scope of the invention will become apparent to those skilled in the art from the detailed description.

### BRIEF DESCRIPTION OF THE DRAWINGS

The accompanying drawings, which are included to provide a further understanding of the invention and are incorporated in and constitute a part of this specification, illustrate exemplary embodiments and together with the description serve to explain the principles of the invention.

In the drawings:

FIG. 1A is a block diagram of a mobile terminal in accordance with the present disclosure.

FIGS. 1B and 1C are conceptual views of one example of a mobile terminal, viewed from different directions.

FIG. 1D is a view illustrating a front side of a mobile terminal related to the present disclosure.

FIG. 2 is a flow chart illustrating a method for processing images captured through at least two cameras having different angles of view.

FIGS. 3A, 3B, 3C, and 4 are conceptual views illustrating a control method of FIG. 2.

FIGS. 5A and 5B are conceptual views illustrating a method for synthesizing a first image and a second image on the basis of a user setting.

FIGS. 6, 7A, and 7B are conceptual views illustrating a method for sequentially capturing images through a first camera and a second camera and synthesizing the captured images.

FIGS. 8A, 8B, 9A, and 9B are conceptual views illustrating a method for capturing images through a first camera and a second camera having different angles of view and synthesizing the images to generate a synthesized image.

FIGS. 10A and 10B are conceptual views illustrating a method for capturing video with images received through a plurality of cameras.

FIGS. 11A, 11B, and 11C are conceptual views illustrating a method for capturing video and a still image through a plurality of cameras.

### DETAILED DESCRIPTION OF THE INVENTION

Description will now be given in detail according to exemplary embodiments disclosed herein, with reference to the accompanying drawings. For the sake of brief description with reference to the drawings, the same or equivalent components may be provided with the same or similar reference numbers, and description thereof will not be repeated. In general, a suffix such as “module” and “unit” may be used to refer to elements or components. Use of such a suffix herein is merely intended to facilitate description of the specification, and the suffix itself is not intended to give any special meaning or function. In the present disclosure, that which is well-known to one of ordinary skill in the relevant art has generally been omitted for the sake of brevity. The accompanying drawings are used to help easily understand various technical features and it should be understood that the embodiments presented herein are not limited by the accompanying drawings. As such, the present disclosure should be construed to extend to any alterations, equivalents and substitutes in addition to those which are particularly set out in the accompanying drawings.

It will be understood that although the terms first, second, etc. may be used herein to describe various elements, these elements should not be limited by these terms. These terms are generally only used to distinguish one element from another.

It will be understood that when an element is referred to as being “connected with” another element, the element can be connected with the other element or intervening elements may also be present. In contrast, when an element is referred to as being “directly connected with” another element, there are no intervening elements present.

A singular representation may include a plural representation unless it represents a definitely different meaning from the context. Terms such as “include” or “has” are used herein and should be understood that they are intended to indicate an existence of several components, functions or steps, disclosed in the specification, and it is also understood that greater or fewer components, functions, or steps may likewise be utilized.

Mobile terminals presented herein may be implemented using a variety of different types of terminals. Examples of such terminals include cellular phones, smart phones, user equipment, laptop computers, digital broadcast terminals, personal digital assistants (PDAs), portable multimedia players (PMPs), navigators, portable computers (PCs), slate PCs, tablet PCs, ultra books, wearable devices (for example, smart watches, smart glasses, head mounted displays (HMDs)), and the like.

By way of non-limiting example only, further description will be made with reference to particular types of mobile terminals. However, such teachings apply equally to other types of terminals, such as those types noted above. In addition, these teachings may also be applied to stationary terminals such as digital TV, desktop computers, and the like.

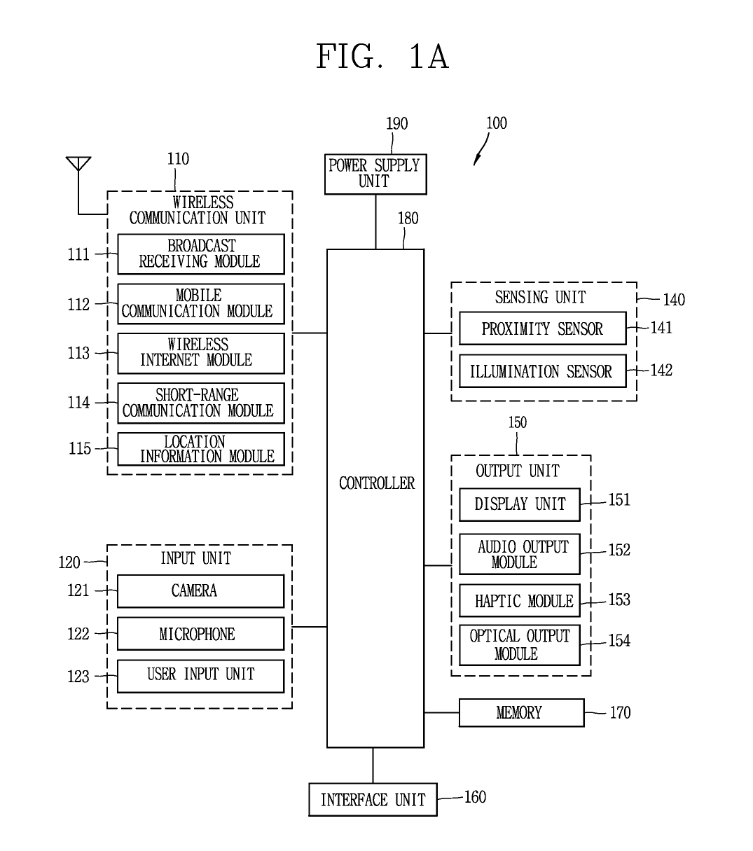

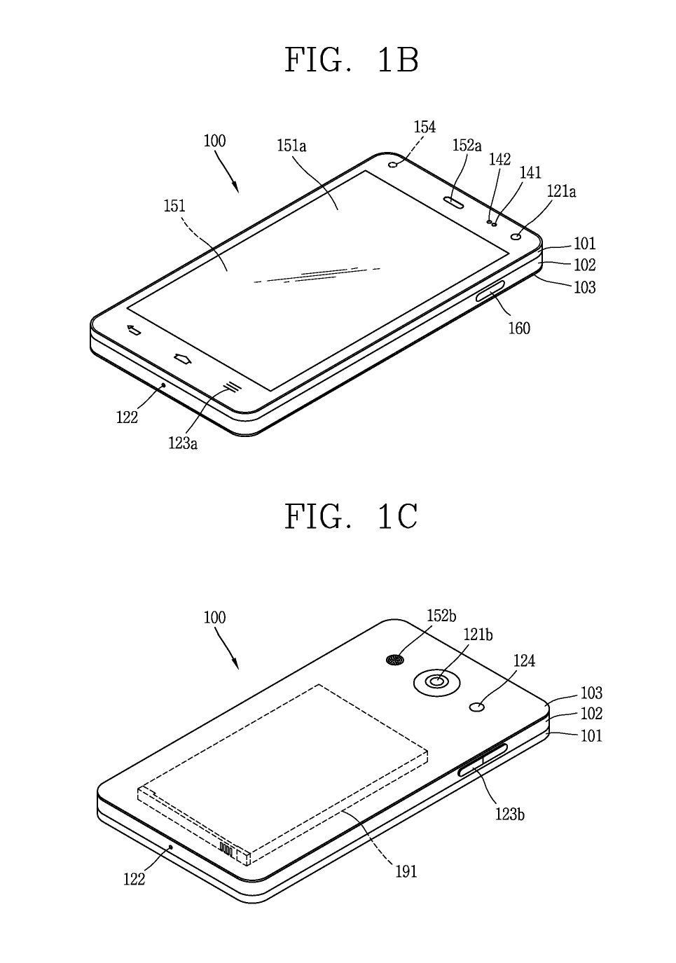

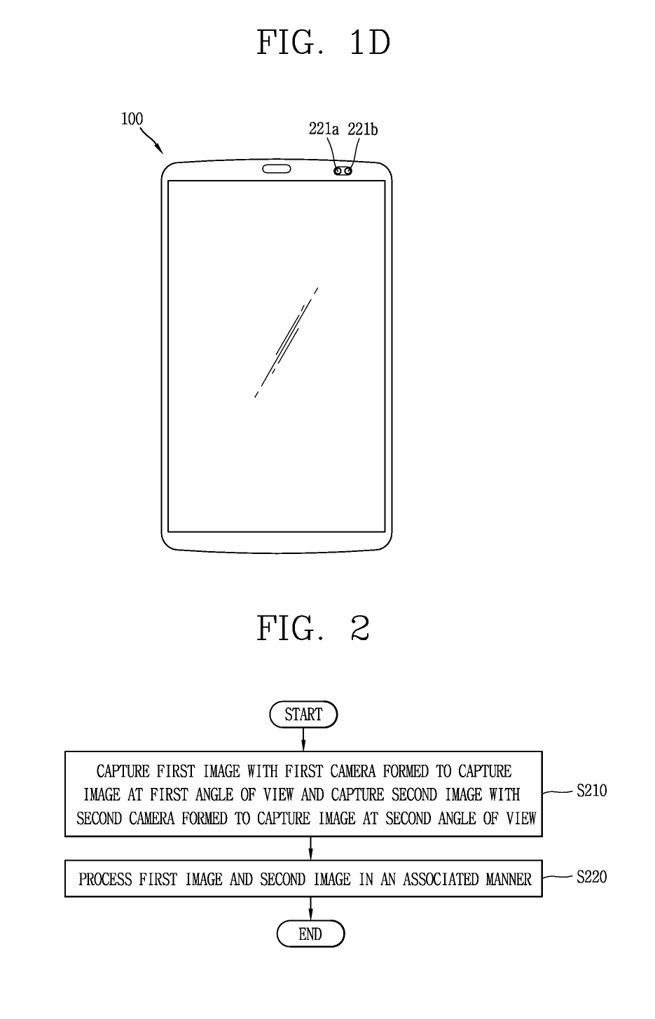

Reference is now made to FIGS. 1A-1C, where FIG. 1A is a block diagram of a mobile terminal in accordance with the present disclosure, and FIGS. 1B and 1C are conceptual views of one example of the mobile terminal, viewed from different directions.

The mobile terminal 100 is shown having components such as a wireless communication unit 110, an input unit 120, a sensing unit 140, an output unit 150, an interface unit 160, a memory 170, a controller 180, and a power supply unit 190. It is understood that implementing all of the illustrated components is not a requirement, and that greater or fewer components may alternatively be implemented.

Referring now to FIG. 1A, the mobile terminal 100 is shown having wireless communication unit 110 configured with several commonly implemented components. For instance, the wireless communication unit 110 typically includes one or more components which permit wireless communication between the mobile terminal 100 and a wireless communication system or network within which the mobile terminal is located.

The wireless communication unit 110 typically includes one or more modules which permit communications such as wireless communications between the mobile terminal 100 and a wireless communication system, communications between the mobile terminal 100 and another mobile terminal, communications between the mobile terminal 100 and an external server. Further, the wireless communication unit 110 typically includes one or more modules which connect the mobile terminal 100 to one or more networks. To facilitate such communications, the wireless communication unit 110 includes one or more of a broadcast receiving module 111, a mobile communication module 112, a wireless Internet module 113, a short-range communication module 114, and a location information module 115.

The input unit 120 includes a camera 121 for obtaining images or video, a microphone 122, which is one type of audio input device for inputting an audio signal, and a user input unit 123 (for example, a touch key, a push key, a mechanical key, a soft key, and the like) for allowing a user to input information. Data (for example, audio, video, image, and the like) is obtained by the input unit 120 and may be analyzed and processed by controller 180 according to device parameters, user commands, and combinations thereof.

The sensing unit 140 is typically implemented using one or more sensors configured to sense internal information of the mobile terminal, the surrounding environment of the mobile terminal, user information, and the like. For example, in FIG. 1A, the sensing unit 140 is shown having a proximity sensor 141 and an illumination sensor 142.

If desired, the sensing unit 140 may alternatively or additionally include other types of sensors or devices, such as a touch sensor, an acceleration sensor, a magnetic sensor, a G-sensor, a gyroscope sensor, a motion sensor, an RGB sensor, an infrared (IR) sensor, a finger scan sensor, a ultrasonic sensor, an optical sensor (for example, camera 121), a microphone 122, a battery gauge, an environment sensor (for example, a barometer, a hygrometer, a thermometer, a radiation detection sensor, a thermal sensor, and a gas sensor, among others), and a chemical sensor (for example, an electronic nose, a health care sensor, a biometric sensor, and the like), to name a few. The mobile terminal 100 may be configured to utilize information obtained from sensing unit 140, and in particular, information obtained from one or more sensors of the sensing unit 140, and combinations thereof.

The output unit 150 is typically configured to output various types of information, such as audio, video, tactile output, and the like. The output unit 150 is shown having a display unit 151, an audio output module 152, a haptic module 153, and an optical output module 154.

The display unit 151 may have an inter-layered structure or an integrated structure with a touch sensor in order to facilitate a touch screen. The touch screen may provide an output interface between the mobile terminal 100 and a user, as well as function as the user input unit 123 which provides an input interface between the mobile terminal 100 and the user.

The interface unit 160 serves as an interface with various types of external devices that can be coupled to the mobile terminal 100. The interface unit 160, for example, may include any of wired or wireless ports, external power supply ports, wired or wireless data ports, memory card ports, ports for connecting a device having an identification module, audio input/output (I/O) ports, video I/O ports, earphone ports, and the like. In some cases, the mobile terminal 100 may perform assorted control functions associated with a connected external device, in response to the external device being connected to the interface unit 160.

The memory 170 is typically implemented to store data to support various functions or features of the mobile terminal 100. For instance, the memory 170 may be configured to store application programs executed in the mobile terminal 100, data or instructions for operations of the mobile terminal 100, and the like. Some of these application programs may be downloaded from an external server via wireless communication. Other application programs may be installed within the mobile terminal 100 at time of manufacturing or shipping, which is typically the case for basic functions of the mobile terminal 100 (for example, receiving a call, placing a call, receiving a message, sending a message, and the like). It is common for application programs to be stored in the memory 170, installed in the mobile terminal 100, and executed by the controller 180 to perform an operation (or function) for the mobile terminal 100.

The controller 180 typically functions to control overall operation of the mobile terminal 100, in addition to the operations associated with the application programs. The controller 180 may provide or process information or functions appropriate for a user by processing signals, data, information and the like, which are input or output by the various components depicted in FIG. 1A, or activating application programs stored in the memory 170. As one example, the controller 180 controls some or all of the components illustrated in FIGS. 1A-1C according to the execution of an application program that have been stored in the memory 170.

The power supply unit 190 can be configured to receive external power or provide internal power in order to supply appropriate power required for operating elements and components included in the mobile terminal 100. The power supply unit 190 may include a battery, and the battery may be configured to be embedded in the terminal body, or configured to be detachable from the terminal body.

Referring still to FIG. 1A, various components depicted in this figure will now be described in more detail. Regarding the wireless communication unit 110, the broadcast receiving module 111 is typically configured to receive a broadcast signal and/or broadcast associated information from an external broadcast managing entity via a broadcast channel. The broadcast channel may include a satellite channel, a terrestrial channel, or both. In some embodiments, two or more broadcast receiving modules 111 may be utilized to facilitate simultaneously receiving of two or more broadcast channels, or to support switching among broadcast channels.

The mobile communication module 112 can transmit and/or receive wireless signals to and from one or more network entities. Typical examples of a network entity include a base station, an external mobile terminal, a server, and the like. Such network entities form part of a mobile communication network, which is constructed according to technical standards or communication methods for mobile communications (for example, Global System for Mobile Communication (GSM), Code Division Multi Access (CDMA), CDMA2000 (Code Division Multi Access 2000), EV-DO (Enhanced Voice-Data Optimized or Enhanced Voice-Data Only), Wideband CDMA (WCDMA), High Speed Downlink Packet access (HSDPA), HSUPA (High Speed Uplink Packet Access), Long Term Evolution (LTE), LTE-A (Long Term Evolution-Advanced), and the like).

Examples of wireless signals transmitted and/or received via the mobile communication module 112 include audio call signals, video (telephony) call signals, or various formats of data to support communication of text and multimedia messages.

The wireless Internet module 113 is configured to facilitate wireless Internet access. This module may be internally or externally coupled to the mobile terminal 100. The wireless Internet module 113 may transmit and/or receive wireless signals via communication networks according to wireless Internet technologies.

Examples of such wireless Internet access include Wireless LAN (WLAN), Wireless Fidelity (Wi-Fi), Wi-Fi Direct, Digital Living Network Alliance (DLNA), Wireless Broadband (WiBro), Worldwide Interoperability for Microwave Access (WiMAX), High Speed Downlink Packet Access (HSDPA), HSUPA (High Speed Uplink Packet Access), Long Term Evolution (LTE), LTE-A (Long Term Evolution-Advanced), and the like. The wireless Internet module 113 may transmit/receive data according to one or more of such wireless Internet technologies, and other Internet technologies as well.

In some embodiments, when the wireless Internet access is implemented according to, for example, WiBro, HSDPA, HSUPA, GSM, CDMA, WCDMA, LTE, LTE-A and the like, as part of a mobile communication network, the wireless Internet module 113 performs such wireless Internet access. As such, the Internet module 113 may cooperate with, or function as, the mobile communication module 112.

The short-range communication module 114 is configured to facilitate short-range communications. Suitable technologies for implementing such short-range communications include BLUETOOTH™, Radio Frequency IDentification (RFID), Infrared Data Association (IrDA), Ultra-WideBand (UWB), ZigBee, Near Field Communication (NFC), Wireless-Fidelity (Wi-Fi), Wi-Fi Direct, Wireless USB (Wireless Universal Serial Bus), and the like. The short-range communication module 114 in general supports wireless communications between the mobile terminal 100 and a wireless communication system, communications between the mobile terminal 100 and another mobile terminal 100, or communications between the mobile terminal and a network where another mobile terminal 100 (or an external server) is located, via wireless area networks. One example of the wireless area networks is a wireless personal area networks.

In some embodiments, another mobile terminal (which may be configured similarly to mobile terminal 100) may be a wearable device, for example, a smart watch, a smart glass or a head mounted display (HMD), which is able to exchange data with the mobile terminal 100 (or otherwise cooperate with the mobile terminal 100). The short-range communication module 114 may sense or recognize the wearable device, and permit communication between the wearable device and the mobile terminal 100. In addition, when the sensed wearable device is a device which is authenticated to communicate with the mobile terminal 100, the controller 180, for example, may cause transmission of data processed in the mobile terminal 100 to the wearable device via the short-range communication module 114. Hence, a user of the wearable device may use the data processed in the mobile terminal 100 on the wearable device. For example, when a call is received in the mobile terminal 100, the user may answer the call using the wearable device. Also, when a message is received in the mobile terminal 100, the user can check the received message using the wearable device.

The location information module 115 is generally configured to detect, calculate, derive or otherwise identify a position of the mobile terminal. As an example, the location information module 115 includes a Global Position System (GPS) module, a Wi-Fi module, or both. If desired, the location information module 115 may alternatively or additionally function with any of the other modules of the wireless communication unit 110 to obtain data related to the position of the mobile terminal.

As one example, when the mobile terminal uses a GPS module, a position of the mobile terminal may be acquired using a signal sent from a GPS satellite. As another example, when the mobile terminal uses the Wi-Fi module, a position of the mobile terminal can be acquired based on information related to a wireless access point (AP) which transmits or receives a wireless signal to or from the Wi-Fi module.

The input unit 120 may be configured to permit various types of input to the mobile terminal 120. Examples of such input include audio, image, video, data, and user input. Image and video input is often obtained using one or more cameras 121. Such cameras 121 may process image frames of still pictures or video obtained by image sensors in a video or image capture mode. The processed image frames can be displayed on the display unit 151 or stored in memory 170. In some cases, the cameras 121 may be arranged in a matrix configuration to permit a plurality of images having various angles or focal points to be input to the mobile terminal 100. As another example, the cameras 121 may be located in a stereoscopic arrangement to acquire left and right images for implementing a stereoscopic image.

The microphone 122 is generally implemented to permit audio input to the mobile terminal 100. The audio input can be processed in various manners according to a function being executed in the mobile terminal 100. If desired, the microphone 122 may include assorted noise removing algorithms to remove unwanted noise generated in the course of receiving the external audio.

The user input unit 123 is a component that permits input by a user. Such user input may enable the controller 180 to control operation of the mobile terminal 100. The user input unit 123 may include one or more of a mechanical input element (for example, a key, a button located on a front and/or rear surface or a side surface of the mobile terminal 100, a dome switch, a jog wheel, a jog switch, and the like), or a touch-sensitive input, among others. As one example, the touch-sensitive input may be a virtual key or a soft key, which is displayed on a touch screen through software processing, or a touch key which is located on the mobile terminal at a location that is other than the touch screen. On the other hand, the virtual key or the visual key may be displayed on the touch screen in various shapes, for example, graphic, text, icon, video, or a combination thereof.

The sensing unit 140 is generally configured to sense one or more of internal information of the mobile terminal, surrounding environment information of the mobile terminal, user information, or the like. The controller 180 generally cooperates with the sending unit 140 to control operation of the mobile terminal 100 or execute data processing, a function or an operation associated with an application program installed in the mobile terminal based on the sensing provided by the sensing unit 140. The sensing unit 140 may be implemented using any of a variety of sensors, some of which will now be described in more detail.

The proximity sensor 141 may include a sensor to sense presence or absence of an object approaching a surface, or an object located near a surface, by using an electromagnetic field, infrared rays, or the like without a mechanical contact. The proximity sensor 141 may be arranged at an inner region of the mobile terminal covered by the touch screen, or near the touch screen.

The proximity sensor 141, for example, may include any of a transmissive type photoelectric sensor, a direct reflective type photoelectric sensor, a mirror reflective type photoelectric sensor, a high-frequency oscillation proximity sensor, a capacitance type proximity sensor, a magnetic type proximity sensor, an infrared rays proximity sensor, and the like. When the touch screen is implemented as a capacitance type, the proximity sensor 141 can sense proximity of a pointer relative to the touch screen by changes of an electromagnetic field, which is responsive to an approach of an object with conductivity. In this case, the touch screen (touch sensor) may also be categorized as a proximity sensor.

The term “proximity touch” will often be referred to herein to denote the scenario in which a pointer is positioned to be proximate to the touch screen without contacting the touch screen. The term “contact touch” will often be referred to herein to denote the scenario in which a pointer makes physical contact with the touch screen. For the position corresponding to the proximity touch of the pointer relative to the touch screen, such position will correspond to a position where the pointer is perpendicular to the touch screen. The proximity sensor 141 may sense proximity touch, and proximity touch patterns (for example, distance, direction, speed, time, position, moving status, and the like).

In general, controller 180 processes data corresponding to proximity touches and proximity touch patterns sensed by the proximity sensor 141, and cause output of visual information on the touch screen. In addition, the controller 180 can control the mobile terminal 100 to execute different operations or process different data according to whether a touch with respect to a point on the touch screen is either a proximity touch or a contact touch.

A touch sensor can sense a touch applied to the touch screen, such as display unit 151, using any of a variety of touch methods. Examples of such touch methods include a resistive type, a capacitive type, an infrared type, and a magnetic field type, among others.

As one example, the touch sensor may be configured to convert changes of pressure applied to a specific part of the display unit 151, or convert capacitance occurring at a specific part of the display unit 151, into electric input signals. The touch sensor may also be configured to sense not only a touched position and a touched area, but also touch pressure and/or touch capacitance. A touch object is generally used to apply a touch input to the touch sensor. Examples of typical touch objects include a finger, a touch pen, a stylus pen, a pointer, or the like.

When a touch input is sensed by a touch sensor, corresponding signals may be transmitted to a touch controller. The touch controller may process the received signals, and then transmit corresponding data to the controller 180. Accordingly, the controller 180 may sense which region of the display unit 151 has been touched. Here, the touch controller may be a component separate from the controller 180, the controller 180, and combinations thereof.

In some embodiments, the controller 180 may execute the same or different controls according to a type of touch object that touches the touch screen or a touch key provided in addition to the touch screen. Whether to execute the same or different control according to the object which provides a touch input may be decided based on a current operating state of the mobile terminal 100 or a currently executed application program, for example.

The touch sensor and the proximity sensor may be implemented individually, or in combination, to sense various types of touches. Such touches includes a short (or tap) touch, a long touch, a multi-touch, a drag touch, a flick touch, a pinch-in touch, a pinch-out touch, a swipe touch, a hovering touch, and the like.

If desired, an ultrasonic sensor may be implemented to recognize position information relating to a touch object using ultrasonic waves. The controller 180, for example, may calculate a position of a wave generation source based on information sensed by an illumination sensor and a plurality of ultrasonic sensors. Since light is much faster than ultrasonic waves, the time for which the light reaches the optical sensor is much shorter than the time for which the ultrasonic wave reaches the ultrasonic sensor. The position of the wave generation source may be calculated using this fact. For instance, the position of the wave generation source may be calculated using the time difference from the time that the ultrasonic wave reaches the sensor based on the light as a reference signal.

The camera 121 typically includes at least one a camera sensor (CCD, CMOS etc.), a photo sensor (or image sensors), and a laser sensor.

Implementing the camera 121 with a laser sensor may allow detection of a touch of a physical object with respect to a 3D stereoscopic image. The photo sensor may be laminated on, or overlapped with, the display device. The photo sensor may be configured to scan movement of the physical object in proximity to the touch screen. In more detail, the photo sensor may include photo diodes and transistors at rows and columns to scan content received at the photo sensor using an electrical signal which changes according to the quantity of applied light. Namely, the photo sensor may calculate the coordinates of the physical object according to variation of light to thus obtain position information of the physical object.

The display unit 151 is generally configured to output information processed in the mobile terminal 100. For example, the display unit 151 may display execution screen information of an application program executing at the mobile terminal 100 or user interface (UI) and graphic user interface (GUI) information in response to the execution screen information.

In some embodiments, the display unit 151 may be implemented as a stereoscopic display unit for displaying stereoscopic images. A typical stereoscopic display unit may employ a stereoscopic display scheme such as a stereoscopic scheme (a glass scheme), an auto-stereoscopic scheme (glassless scheme), a projection scheme (holographic scheme), or the like.

The audio output module 152 is generally configured to output audio data. Such audio data may be obtained from any of a number of different sources, such that the audio data may be received from the wireless communication unit 110 or may have been stored in the memory 170. The audio data may be output during modes such as a signal reception mode, a call mode, a record mode, a voice recognition mode, a broadcast reception mode, and the like. The audio output module 152 can provide audible output related to a particular function (e.g., a call signal reception sound, a message reception sound, etc.) performed by the mobile terminal 100. The audio output module 152 may also be implemented as a receiver, a speaker, a buzzer, or the like.

A haptic module 153 can be configured to generate various tactile effects that a user feels, perceive, or otherwise experience. A typical example of a tactile effect generated by the haptic module 153 is vibration. The strength, pattern and the like of the vibration generated by the haptic module 153 can be controlled by user selection or setting by the controller. For example, the haptic module 153 may output different vibrations in a combining manner or a sequential manner.

Besides vibration, the haptic module 153 can generate various other tactile effects, including an effect by stimulation such as a pin arrangement vertically moving to contact skin, a spray force or suction force of air through a jet orifice or a suction opening, a touch to the skin, a contact of an electrode, electrostatic force, an effect by reproducing the sense of cold and warmth using an element that can absorb or generate heat, and the like.

The haptic module 153 can also be implemented to allow the user to feel a tactile effect through a muscle sensation such as the user's fingers or arm, as well as transferring the tactile effect through direct contact. Two or more haptic modules 153 may be provided according to the particular configuration of the mobile terminal 100.

An optical output module 154 can output a signal for indicating an event generation using light of a light source. Examples of events generated in the mobile terminal 100 may include message reception, call signal reception, a missed call, an alarm, a schedule notice, an email reception, information reception through an application, and the like.

A signal output by the optical output module 154 may be implemented in such a manner that the mobile terminal emits monochromatic light or light with a plurality of colors. The signal output may be terminated as the mobile terminal senses that a user has checked the generated event, for example.

The interface unit 160 serves as an interface for external devices to be connected with the mobile terminal 100. For example, the interface unit 160 can receive data transmitted from an external device, receive power to transfer to elements and components within the mobile terminal 100, or transmit internal data of the mobile terminal 100 to such external device. The interface unit 160 may include wired or wireless headset ports, external power supply ports, wired or wireless data ports, memory card ports, ports for connecting a device having an identification module, audio input/output (I/O) ports, video I/O ports, earphone ports, or the like.

The identification module may be a chip that stores various information for authenticating authority of using the mobile terminal 100 and may include a user identity module (UIM), a subscriber identity module (SIM), a universal subscriber identity module (USIM), and the like. In addition, the device having the identification module (also referred to herein as an “identifying device”) may take the form of a smart card. Accordingly, the identifying device can be connected with the terminal 100 via the interface unit 160.

When the mobile terminal 100 is connected with an external cradle, the interface unit 160 can serve as a passage to allow power from the cradle to be supplied to the mobile terminal 100 or may serve as a passage to allow various command signals input by the user from the cradle to be transferred to the mobile terminal there through. Various command signals or power input from the cradle may operate as signals for recognizing that the mobile terminal is properly mounted on the cradle.

The memory 170 can store programs to support operations of the controller 180 and store input/output data (for example, phonebook, messages, still images, videos, etc.). The memory 170 may store data related to various patterns of vibrations and audio which are output in response to touch inputs on the touch screen.

The memory 170 may include one or more types of storage mediums including a Flash memory, a hard disk, a solid state disk, a silicon disk, a multimedia card micro type, a card-type memory (e.g., SD or DX memory, etc), a Random Access Memory (RAM), a Static Random Access Memory (SRAM), a Read-Only Memory (ROM), an Electrically Erasable Programmable Read-Only Memory (EEPROM), a Programmable Read-Only memory (PROM), a magnetic memory, a magnetic disk, an optical disk, and the like. The mobile terminal 100 may also be operated in relation to a network storage device that performs the storage function of the memory 170 over a network, such as the Internet.

The controller 180 may typically control the general operations of the mobile terminal 100. For example, the controller 180 may set or release a lock state for restricting a user from inputting a control command with respect to applications when a status of the mobile terminal meets a preset condition.

The controller 180 can also perform the controlling and processing associated with voice calls, data communications, video calls, and the like, or perform pattern recognition processing to recognize a handwriting input or a picture drawing input performed on the touch screen as characters or images, respectively. In addition, the controller 180 can control one or a combination of those components in order to implement various exemplary embodiments disclosed herein.

The power supply unit 190 receives external power or provide internal power and supply the appropriate power required for operating respective elements and components included in the mobile terminal 100. The power supply unit 190 may include a battery, which is typically rechargeable or be detachably coupled to the terminal body for charging.

The power supply unit 190 may include a connection port. The connection port may be configured as one example of the interface unit 160 to which an external charger for supplying power to recharge the battery is electrically connected.

As another example, the power supply unit 190 may be configured to recharge the battery in a wireless manner without use of the connection port. In this example, the power supply unit 190 can receive power, transferred from an external wireless power transmitter, using at least one of an inductive coupling method which is based on magnetic induction or a magnetic resonance coupling method which is based on electromagnetic resonance.

Various embodiments described herein may be implemented in a computer-readable medium, a machine-readable medium, or similar medium using, for example, software, hardware, or any combination thereof.

Referring now to FIGS. 1B and 1C, the mobile terminal 100 is described with reference to a bar-type terminal body. However, the mobile terminal 100 may alternatively be implemented in any of a variety of different configurations. Examples of such configurations include watch-type, clip-type, glasses-type, or as a folder-type, flip-type, slide-type, swing-type, and swivel-type in which two and more bodies are combined with each other in a relatively movable manner, and combinations thereof. Discussion herein will often relate to a particular type of mobile terminal (for example, bar-type, watch-type, glasses-type, and the like). However, such teachings with regard to a particular type of mobile terminal will generally apply to other types of mobile terminals as well.

The mobile terminal 100 will generally include a case (for example, frame, housing, cover, and the like) forming the appearance of the terminal. In this embodiment, the case is formed using a front case 101 and a rear case 102. Various electronic components are incorporated into a space formed between the front case 101 and the rear case 102. At least one middle case may be additionally positioned between the front case 101 and the rear case 102.

The display unit 151 is shown located on the front side of the terminal body to output information. As illustrated, a window 151a of the display unit 151 may be mounted to the front case 101 to form the front surface of the terminal body together with the front case 101.

In some embodiments, electronic components may also be mounted to the rear case 102. Examples of such electronic components include a detachable battery 191, an identification module, a memory card, and the like. Rear cover 103 is shown covering the electronic components, and this cover may be detachably coupled to the rear case 102. Therefore, when the rear cover 103 is detached from the rear case 102, the electronic components mounted to the rear case 102 are externally exposed.

As illustrated, when the rear cover 103 is coupled to the rear case 102, a side surface of the rear case 102 is partially exposed. In some cases, upon the coupling, the rear case 102 may also be completely shielded by the rear cover 103. In some embodiments, the rear cover 103 may include an opening for externally exposing a camera 121b or an audio output module 152b.

The cases 101, 102, 103 may be formed by injection-molding synthetic resin or may be formed of a metal, for example, stainless steel (STS), aluminum (Al), titanium (Ti), or the like.

As an alternative to the example in which the plurality of cases form an inner space for accommodating components, the mobile terminal 100 may be configured such that one case forms the inner space. In this example, a mobile terminal 100 having a uni-body is formed in such a manner that synthetic resin or metal extends from a side surface to a rear surface.

If desired, the mobile terminal 100 may include a waterproofing unit (not shown) for preventing introduction of water into the terminal body. For example, the waterproofing unit may include a waterproofing member which is located between the window 151a and the front case 101, between the front case 101 and the rear case 102, or between the rear case 102 and the rear cover 103, to hermetically seal an inner space when those cases are coupled.

FIGS. 1B and 1C depict certain components as arranged on the mobile terminal. However, it is to be understood that alternative arrangements are possible and within the teachings of the instant disclosure. Some components may be omitted or rearranged. For example, the first manipulation unit 123a may be located on another surface of the terminal body, and the second audio output module 152b may be located on the side surface of the terminal body.

The display unit 151 outputs information processed in the mobile terminal 100. The display unit 151 may be implemented using one or more suitable display devices. Examples of such suitable display devices include a liquid crystal display (LCD), a thin film transistor-liquid crystal display (TFT-LCD), an organic light emitting diode (OLED), a flexible display, a 3-dimensional (3D) display, an e-ink display, and combinations thereof.

The display unit 151 may be implemented using two display devices, which can implement the same or different display technology. For instance, a plurality of the display units 151 may be arranged on one side, either spaced apart from each other, or these devices may be integrated, or these devices may be arranged on different surfaces.

The display unit 151 may also include a touch sensor which senses a touch input received at the display unit. When a touch is input to the display unit 151, the touch sensor may be configured to sense this touch and the controller 180, for example, may generate a control command or other signal corresponding to the touch. The content which is input in the touching manner may be a text or numerical value, or a menu item which can be indicated or designated in various modes.

The touch sensor may be configured in a form of a film having a touch pattern, disposed between the window 151a and a display on a rear surface of the window 151a, or a metal wire which is patterned directly on the rear surface of the window 151a. Alternatively, the touch sensor may be integrally formed with the display. For example, the touch sensor may be disposed on a substrate of the display or within the display.

The display unit 151 may also form a touch screen together with the touch sensor. Here, the touch screen may serve as the user input unit 123 (see FIG. 1A). Therefore, the touch screen may replace at least some of the functions of the first manipulation unit 123a.

The first audio output module 152a may be implemented in the form of a speaker to output voice audio, alarm sounds, multimedia audio reproduction, and the like.

The window 151a of the display unit 151 will typically include an aperture to permit audio generated by the first audio output module 152a to pass. One alternative is to allow audio to be released along an assembly gap between the structural bodies (for example, a gap between the window 151a and the front case 101). In this case, a hole independently formed to output audio sounds may not be seen or is otherwise hidden in terms of appearance, thereby further simplifying the appearance and manufacturing of the mobile terminal 100.

The optical output module 154 can be configured to output light for indicating an event generation. Examples of such events include a message reception, a call signal reception, a missed call, an alarm, a schedule notice, an email reception, information reception through an application, and the like. When a user has checked a generated event, the controller can control the optical output unit 154 to stop the light output.

The first camera 121a can process image frames such as still or moving images obtained by the image sensor in a capture mode or a video call mode. The processed image frames can then be displayed on the display unit 151 or stored in the memory 170.

The first and second manipulation units 123a and 123b are examples of the user input unit 123, which may be manipulated by a user to provide input to the mobile terminal 100. The first and second manipulation units 123a and 123b may also be commonly referred to as a manipulating portion, and may employ any tactile method that allows the user to perform manipulation such as touch, push, scroll, or the like. The first and second manipulation units 123a and 123b may also employ any non-tactile method that allows the user to perform manipulation such as proximity touch, hovering, or the like.

FIG. 1B illustrates the first manipulation unit 123a as a touch key, but possible alternatives include a mechanical key, a push key, a touch key, and combinations thereof.

Input received at the first and second manipulation units 123a and 123b may be used in various ways. For example, the first manipulation unit 123a may be used by the user to provide an input to a menu, home key, cancel, search, or the like, and the second manipulation unit 123b may be used by the user to provide an input to control a volume level being output from the first or second audio output modules 152a or 152b, to switch to a touch recognition mode of the display unit 151, or the like.

As another example of the user input unit 123, a rear input unit (not shown) may be located on the rear surface of the terminal body. The rear input unit can be manipulated by a user to provide input to the mobile terminal 100. The input may be used in a variety of different ways. For example, the rear input unit may be used by the user to provide an input for power on/off, start, end, scroll, control volume level being output from the first or second audio output modules 152a or 152b, switch to a touch recognition mode of the display unit 151, and the like. The rear input unit may be configured to permit touch input, a push input, or combinations thereof.

The rear input unit may be located to overlap the display unit 151 of the front side in a thickness direction of the terminal body. As one example, the rear input unit may be located on an upper end portion of the rear side of the terminal body such that a user can easily manipulate it using a forefinger when the user grabs the terminal body with one hand. Alternatively, the rear input unit can be positioned at most any location of the rear side of the terminal body.

Embodiments that include the rear input unit may implement some or all of the functionality of the first manipulation unit 123a in the rear input unit. As such, in situations where the first manipulation unit 123a is omitted from the front side, the display unit 151 can have a larger screen.

As a further alternative, the mobile terminal 100 may include a finger scan sensor which scans a user's fingerprint. The controller 180 can then use fingerprint information sensed by the finger scan sensor as part of an authentication procedure. The finger scan sensor may also be installed in the display unit 151 or implemented in the user input unit 123.

The microphone 122 is shown located at an end of the mobile terminal 100, but other locations are possible. If desired, multiple microphones may be implemented, with such an arrangement permitting the receiving of stereo sounds.

The interface unit 160 may serve as a path allowing the mobile terminal 100 to interface with external devices. For example, the interface unit 160 may include one or more of a connection terminal for connecting to another device (for example, an earphone, an external speaker, or the like), a port for near field communication (for example, an Infrared Data Association (IrDA) port, a Bluetooth port, a wireless LAN port, and the like), or a power supply terminal for supplying power to the mobile terminal 100. The interface unit 160 may be implemented in the form of a socket for accommodating an external card, such as Subscriber Identification Module (SIM), User Identity Module (UIM), or a memory card for information storage.

The second camera 121b is shown located at the rear side of the terminal body and includes an image capturing direction that is substantially opposite to the image capturing direction of the first camera unit 121a. If desired, second camera 121a may alternatively be located at other locations, or made to be moveable, in order to have a different image capturing direction from that which is shown.

The second camera 121b can include a plurality of lenses arranged along at least one line. The plurality of lenses may also be arranged in a matrix configuration. The cameras may be referred to as an “array camera.” When the second camera 121b is implemented as an array camera, images may be captured in various manners using the plurality of lenses and images with better qualities.

As shown in FIG. 1C, a flash 124 is shown adjacent to the second camera 121b. When an image of a subject is captured with the camera 121b, the flash 124 may illuminate the subject.

As shown in FIG. 1B, the second audio output module 152b can be located on the terminal body. The second audio output module 152b may implement stereophonic sound functions in conjunction with the first audio output module 152a, and may be also used for implementing a speaker phone mode for call communication.

At least one antenna for wireless communication may be located on the terminal body. The antenna may be installed in the terminal body or formed by the case. For example, an antenna which configures a part of the broadcast receiving module 111 may be retractable into the terminal body. Alternatively, an antenna may be formed using a film attached to an inner surface of the rear cover 103, or a case that includes a conductive material.

A power supply unit 190 for supplying power to the mobile terminal 100 may include a battery 191, which is mounted in the terminal body or detachably coupled to an outside of the terminal body. The battery 191 may receive power via a power source cable connected to the interface unit 160. Also, the battery 191 can be recharged in a wireless manner using a wireless charger. Wireless charging may be implemented by magnetic induction or electromagnetic resonance.

The rear cover 103 is shown coupled to the rear case 102 for shielding the battery 191, to prevent separation of the battery 191, and to protect the battery 191 from an external impact or from foreign material. When the battery 191 is detachable from the terminal body, the rear case 103 may be detachably coupled to the rear case 102.

An accessory for protecting an appearance or assisting or extending the functions of the mobile terminal 100 can also be provided on the mobile terminal 100. As one example of an accessory, a cover or pouch for covering or accommodating at least one surface of the mobile terminal 100 may be provided. The cover or pouch may cooperate with the display unit 151 to extend the function of the mobile terminal 100. Another example of the accessory is a touch pen for assisting or extending a touch input to a touch screen.

Meanwhile, FIG. 1D is a view illustrating a front side of the mobile terminal according to an exemplary embodiment. The mobile terminal according to an embodiment of the present disclosure may include at least two cameras provided to capture images at different angles of view. The angle of view is an image capture range of a lens installed in the cameras. Here, as an angle of view is greater, an image of a larger range may be captured.

As the angle of view of the lens of the camera is greater, a focal length may be shortened. Thus, in a case in which an image is captured with a camera having a lens with a larger angle of view, an image of a large range may be captured. Here, however, due to the larger angle of view, the captured image of a large range may be distorted as much and perspective thereof may be exaggerated.

The lens may be classified as a wide angle lens, a normal lens, and a telephoto lens depending on the angles of view. The normal lens has an angle of view of 45 degrees and a focal length of 50 mm. With respect to the normal lens, a lens having an angle of view greater than 45 degrees may be classified as a wide angle lens, and a lens having an angle of view smaller than 45 degrees may be classified as a telephoto lens.

The mobile terminal may include at least two cameras provided on at least one of a front surface, a side surface, and a rear surface of the main body thereof in order to capture images at different angles of view. For example, as illustrated in FIG. 1D, two cameras 221a and 221b having different angles of view may be disposed to be adjacent to each other on the front surface of the main body. In this case, the two cameras 221a and 221b having different angles of view may have the same image capturing direction.

In an embodiment of the present disclosure, two cameras having different angles of view may be disposed on the rear surface or one side surface of the main body of the mobile terminal, as well as on the front surface thereof. Also, at least two cameras may be disposed mutually different surfaces among the front surface, the side surface, and the rear surface such that the two cameras may have different image capturing directions.

Hereinafter, a method or receiving images from two cameras having different angles of view will be described representatively, but the present disclosure may also be applied in the same manner to three or more cameras. Also, in the present disclosure, an example in which two cameras are provided is described, and the present disclosure may also be applied in the same manner even to a case in which a single camera having two lenses having different angles of view is provided.

Meanwhile, in the following descriptions, the first camera 221a is provided to capture an image at a first angle of view and a second camera 221b is provided to capture an image at a second angle of view, and common contents of the first camera 221a and the second camera 221b will be described with a term of camera 221.

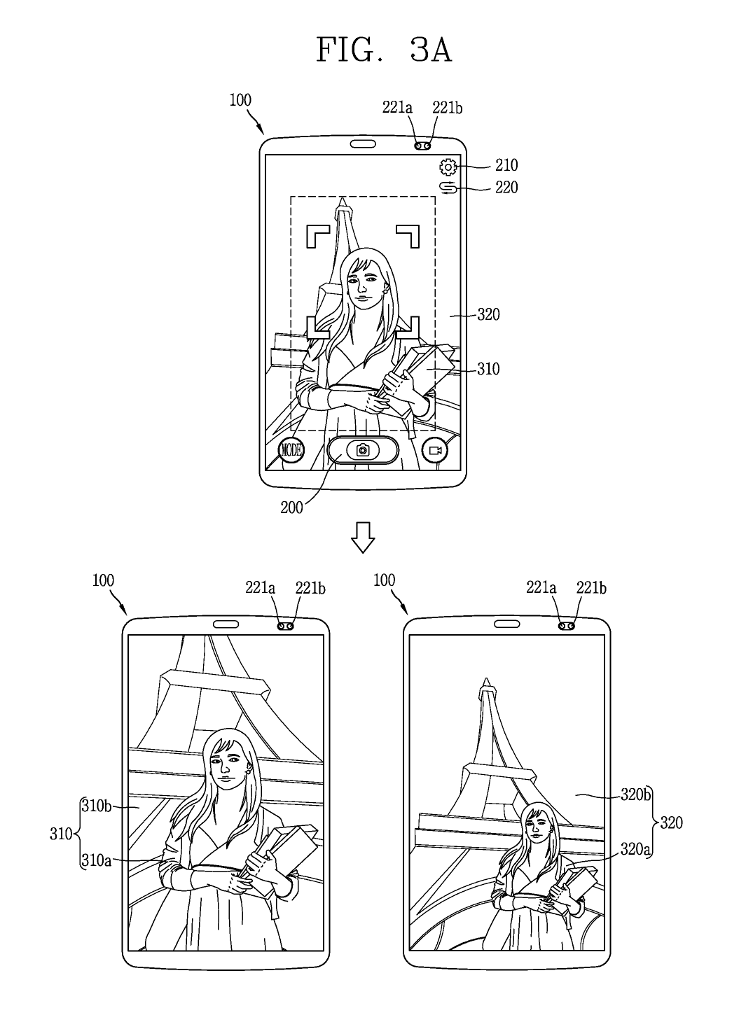

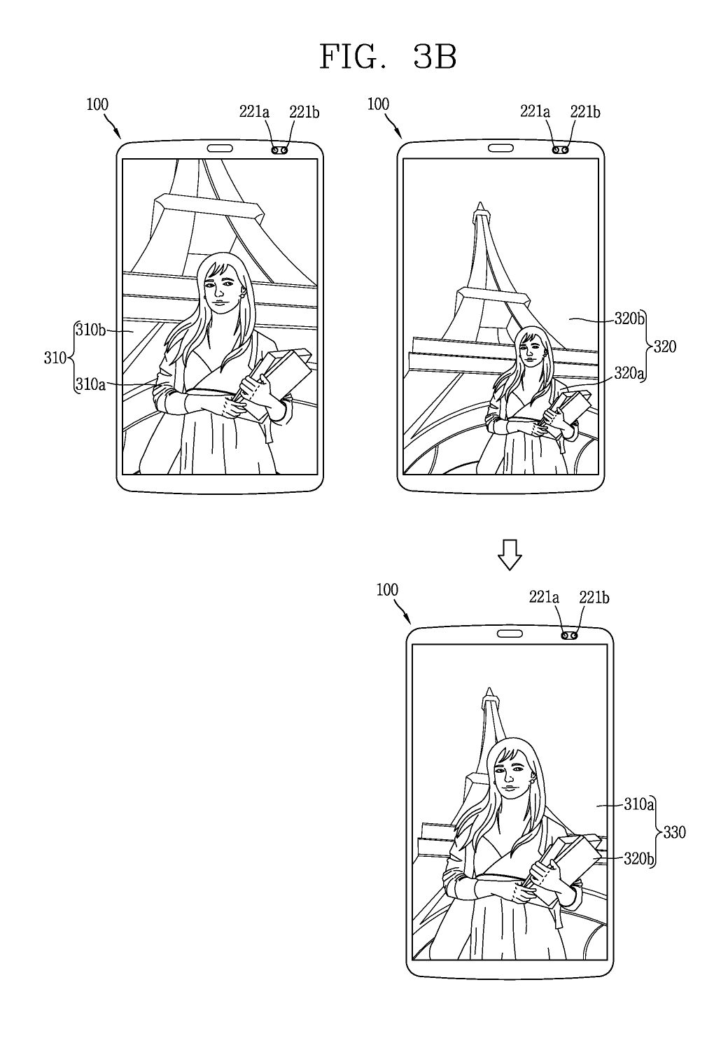

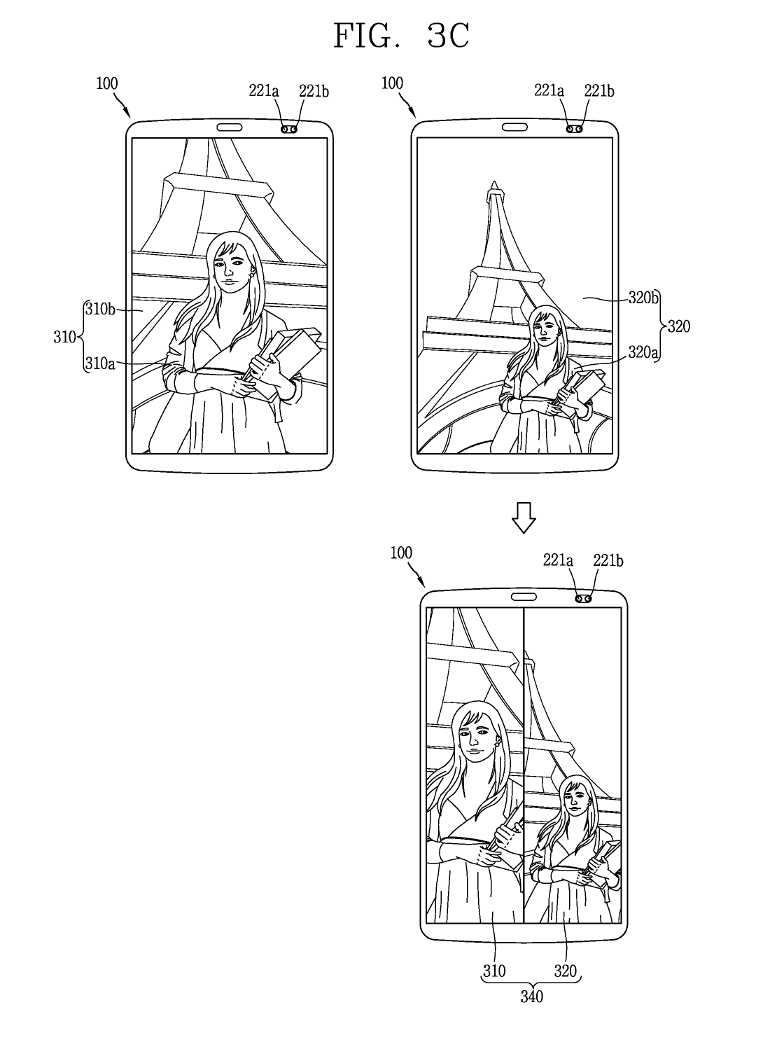

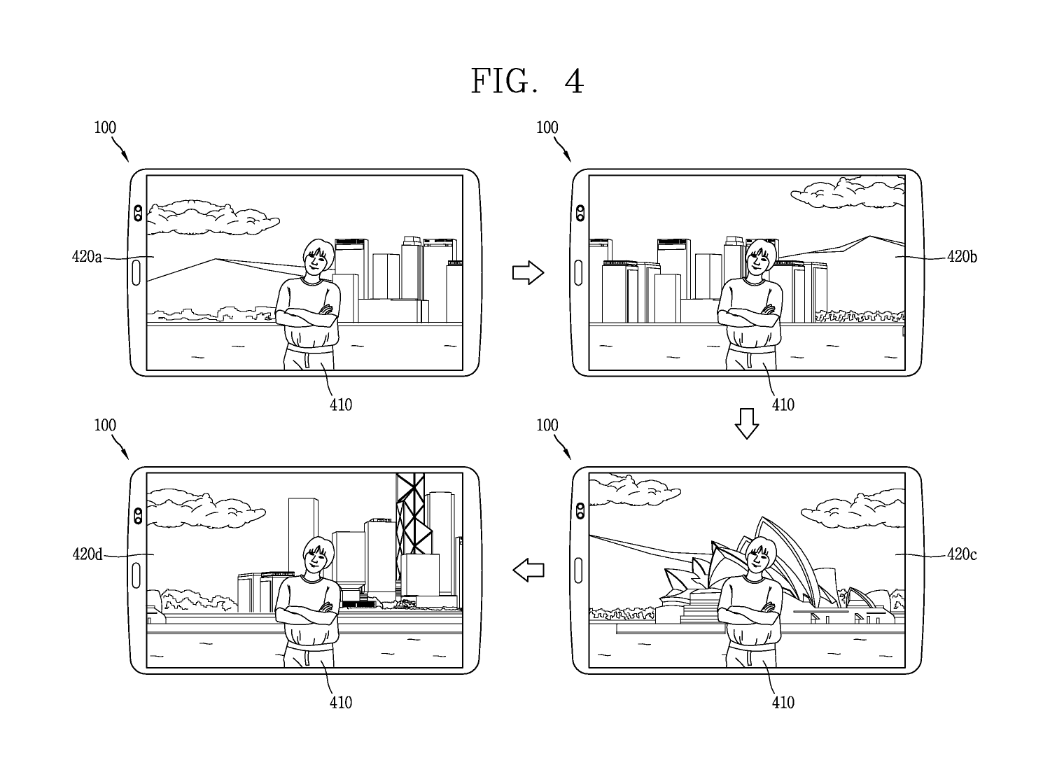

Hereinafter, a method for capturing an image through at least two cameras having different angles of view will be described. FIG. 2 is a flow chart illustrating a method for processing images captured through at least two cameras having different angles of view, and FIGS. 3A, 3B, 3C, and 4 are conceptual views illustrating a control method of FIG. 2.

In the mobile terminal according to an embodiment of the present disclosure, at least two cameras 221a and 221b may be disposed on at least one of the front surface, the side surface, and the rear surface of the terminal body. For example, in the mobile terminal, two cameras 221a and 221b may be disposed to be adjacent to each other on the front surface.

The at least two cameras 221a and 221b may include the first camera 221a and the second camera 221b having different angles of view. For example, the first camera 221a may be provided to capture an image at a first angle of view, and the second camera 221b may be provided to capture an image at a second angle of view greater than the first angle of view. The first camera 221a may be understood as a general camera including a normal lens, and the second camera 221b may be understood as a wide angle camera including a wide angle lens.

The control unit 180 of the mobile terminal may receive an image through at least one of the first camera 221a and the second camera 221b. For example, the control unit 180 may receive an image through the first camera 221a among the first camera 221a and the second camera 221b.

In order to receive an image through the camera, the control unit 180 may activate the camera. Activating the camera 121 may refer to setting the camera 121 to a state in which an image of a subject is received through the camera 121. Conversely, deactivating the camera 121 may refer to setting the camera 121 to a state in which an image of a subject is not received through the camera 121.

The control unit 180 may activate at least one of the first and second cameras 221a and 221b to receive an image from the first and second cameras 221a and 221b. The control unit 180 may select a camera for receiving an image from among the first and second cameras 221a and 221b according to a user request. For example, the control unit 180 may receive an image from the first camera 221a when a user request for receiving an image from the first camera 221a is received.

Also, the control unit 180 may display the image received from the at least one camera on the display unit 151. For example, the control unit 180 may display a first image received from the first camera 221a on the display unit 151.

Also, the control unit 180 may capture an image received from at least one of the first and second cameras 221a and 221b. For example, the control unit 180 may capture only a first image received from the first camera 221a and a second image received from the second camera 221b. Also, the control unit 180 may capture both images received from the first and second cameras 221a and 221b.

Hereinafter, a method for processing different images received from the first and second cameras 221a and 221b in a case in which images received from the first and second cameras 221a and 221b are captured together will be described. However, the present disclosure may also be applied in the same manner to other images separately captured by the first and second cameras 221a and 221b.

First, the control unit of the mobile terminal according to an embodiment of the present disclosure may perform capturing a first image and a second image through the first camera formed to capture an image at a first angle of view and the second camera formed to capture an image at a second angle of view (S210).

The control unit 180 may capture the first image received from the first camera 221a and the second image received from the second camera 221b according to a user request. For example, when the first and second cameras 221a and 221b are activated, the control unit 180 may display preview images of the first image and the second image received from the first and second cameras 221a and 221b on the display unit 151. The preview images are images received from the cameras before the first and second images are captured.

Along with the preview images of the first and second images, a graphic object 200 formed to receive an image capture request, a graphic object 210 for controlling a camera setting value, and a graphic object 220 for camera switching may be further displayed on the display unit 151.

The graphic object 200 formed to receive the image capture request may generate a control command for capturing the image displayed on the display unit 151. That is, when a touch is applied to the graphic object 200 formed to receive the image capture request, the control unit 180 may capture the preview image displayed on the display unit 151. For example, as illustrated in FIG. 3A, when a touch is applied to the graphic object 200 formed to receive the image capture request, the control unit 180 may capture first and second images 310 and 320 together on the preview image.

The first image 310 may be captured at a first angle of view and may include a first partial image 310a including a face image and a second partial image 310b as a remaining portion excluding the first partial image 310a. Similarly, the second image 320 is captured at a second angle of view greater than the first angle of view, and may include a third partial image 320a including a face image and a fourth partial image 320b as a remaining portion excluding the third partial image 320a.

The graphic object 210 for setting the camera setting value may be associated with a function of setting the camera setting value. For example, the function of setting the camera setting value may be an image size setting function, an ISO control function, a face recognition setting function, and the like.

The graphic object 220 for camera switching may be associated with a function of controlling, while an image received through any one camera among the first camera 221a and the second camera 221b is being displayed on the display unit 151, the other camera such that an image received through the other camera different from the any one camera is displayed on the display unit 151.

Alternatively, the graphic object 220 for camera switching may be associated with a function of controlling, while an image received through any one camera among the first camera 221a and the second camera 221b is being displayed on the display unit 151, the any one camera and the other camera such that images received from the any one camera and the other camera are displayed together on the display unit 151.

Alternatively, the graphic object 220 for camera switching may be associated with a function of controlling, while images received through both the first camera 221a and the second camera 221b are being displayed on the display unit 151, the first camera 221a and the second camera 221b such that only an image received from any one camera among the first camera 221a and the second camera 221b is displayed.

Meanwhile, in a case in which the first image and the second image are captured together, the control unit 180 may capture the first image and the second image according to the same image capturing scheme or according to different image capturing schemes.

The image capturing scheme is a scheme of capturing an image. For example, the image capturing scheme may include a video capturing scheme for generating video, a still image capturing scheme for generating a still image, a continuous image capturing scheme for capturing images by a preset number of times at a preset time interval, a person image capturing scheme for capturing a person-centered image, a background image capturing scheme for capturing an image based on a background.

In a case in which the image capturing scheme is in plurality, the control unit 180 may set the image capturing scheme according to a user selection. For example, when a still image capturing scheme for capturing a still image is selected by the user, the control unit 180 may set the camera 121 to capture a still image through the camera 121.

In a case in which images are captured simultaneously or sequentially through the first and second cameras 221a and 221b, both the first and second cameras 221a and 221b may capture images according to the same image capturing scheme or the first and second cameras 221a and 221b may capture images according to different schemes.

For example, as illustrated in FIG. 3A, the control unit 180 may capture all of images received from the first and second cameras 221a and 221b according to the still image capturing scheme. In this case, the image received from the first camera 221a and the image received from the second camera 221b may be captured as still images.

In another example, the control unit 180 may capture the image received from the first camera 221a according to the still image capturing scheme and the image received from the second camera 221b according to the continuous image capturing scheme. In this case, the image received from the first camera 221a may be captured as a still image and the image received from the second camera 221b may be captured as a plurality of predetermined number of still images.

In another example, the control unit 180 may capture the image received from the first camera 221a according to the still image capturing scheme and the image received from the second camera 221b according to the video capturing scheme. In this case, the image received from the first camera 221a may be captured as a still image and the image received from the second camera 221b may be captured as video.

That is, in the mobile terminal according to an embodiment of the present disclosure, images may be simultaneously or sequentially captured according to different image capturing schemes.

When the first and second images are captured through the first and second cameras 221a and 221b, the control unit 180 may perform a step of processing the first image and the second image in an associated manner (S220).

When the first image and the second image are captured, the control unit 180 may process the first image and second image by associating them. In detail, the control unit 180 may synthesize the first image and the second image to generate a synthetic image. Also, apart from the one image, the control unit 180 may separately store the first image and the second image in the memory 170.

Hereinafter, a case of generating a synthetic image by synthesizing the first image and the second image will be described, but the first image and the second image may be separately stored in the memory 170.

The control unit 180 may synthesize at least a portion of the first image with at least a portion of the second image to generate a synthetic image.

Here, the control unit 180 may synthesize the images regardless of whether the first image and the second image have been captured according to the same image capturing scheme or according to different image capturing schemes.

The method for synthesizing the images use various schemes. For example, the control unit 180 may synthesize the first image and the second image on the basis of a preset algorithm or according to a user selection.

The preset algorithm may be an image synthesis algorithm. For example, with respect to the first image and the second image captured through the first camera 221a and the second camera 221b which have different angles of view and which capture images in the same image capturing direction, the preset algorithm may be an algorithm detecting images including the same image and synthesizing the detected images by using them.

In order to synthesize the first image and the second image, the control unit 180 may detect at least portion of the first image and the second image. For example, as illustrated in the second drawing of FIG. 3B, the control unit 180 may detect the first partial image 310a including the face image from the first image 310, as an image of at least a portion to be synthesized with the second image 320. In another example, when a touch drawing a closed curve with respect to the first image is applied, the control unit 180 may detect an inner region of the closed curve as at least a portion of an image to be synthesized.

Thereafter, the control unit 180 may synthesize the detected at least portion of the first image to at least portion of the second image. Here, the control unit 180 may synthesize the at least portion of the first image to the second image on the basis of a preset algorithm. The preset algorithm may be an algorithm for detecting an image corresponding to the at least a portion of the first image from the second image, and replacing it with at least a portion of the first image.

For example, as illustrated in the third drawing of FIG. 3B, the control unit 180 may replace the image corresponding to the first image in the fourth partial image 320b of the second image with the first partial image 310a of the first image to generate a synthesized synthetic image 330.

Alternatively, the control unit 180 may synthesize the first image 310 and the second image 320 in the form of a preset frame to generate a synthetic image. The frame may represent a form of synthesizing images. For example, the frame may be a frame for synthesizing images in such a form that the first image 310 is positioned on the left and the second image 320 is positioned on the right with respect to the front surface of the display unit 151, or may be a frame synthesizing images in such a form that the first image 310 is positioned above and the second image 320 is positioned below. For example, as illustrated in FIG. 3C, the control unit 180 may generate the synthetic image 340 having a structure in which the first image 310 is positioned on the left and the second image 320 is positioned on the right with respect to the front surface of the display unit 151.

In another example, in a case in which the first image and the second image are simultaneously captured, the control unit 180 may synthesize the images in such a form that the first image and the second image are displayed in a preview state on the display unit 151 before being simultaneously captured.

In detail, as illustrated in the first drawing of FIG. 4, the control unit 180 may capture an image of a person according to a person image capturing scheme of capturing a person on the basis of face recognition through the first camera 221a, and may capture an image according to the continuous image capturing scheme of capturing images by a preset number of times with a preset time interval. In this case, as illustrated in the first drawing of FIG. 4, a first image 410 may be an image captured on the basis of a person at a first angle of view, and a second image 420a may be an image captured on the basis of a background. That is, in an embodiment of the present disclosure, since the first and second cameras 221a 221b capture images at different angles of view, the first and second cameras 221a and 221b may obtain different images having different angles of view even in the same image capture direction.

Also, on the basis of an image capture request, the control unit 180 may capture a single image through the first camera 221a and capture a plurality of images through the second camera 221b. For example, as illustrated in the second, third, and fourth drawings of FIG. 4, the control unit 180 may capture four continuous images 420a, 420b, 420c, and 420d through the second camera 221b.

When image capturing is terminated, the control unit 180 may synthesize the single first image 410 captured through the first camera 221a and the four images 420a, 420b, 420c, and 420d captured through the second cameras 221b to generate a single synthetic image.

The synthetic image may be a preset time interval, and the four images may be displayed on the display unit 151 such that the four images are sequentially changed. For example, as illustrated in FIG. 4, the control unit 180 may generate the first image captured by the first camera 221a and the four images captured by the second camera 221b as sub-synthetic images. Thereafter, the control unit 180 may synthesize the images generated as sub-synthetic images to a single synthetic image.

The synthetic image may be generated as a moving image that follows a file standard of graphics interchange format (GIF). In this case, the synthetic image, as an image in the form of moving on the display unit 151, may have an animation effect. For example, as illustrated in the four drawings of FIG. 4, the synthetic image may be an image in which the first image capturing a person is not changed and only the background is automatically changed according to the passage of time.

Thus, the user may create the synthetic image in which the person and the background are appropriately harmonized through the first camera 221a and the second camera 221b formed to have the same image capture direction and formed to capture images at different angles of view.

In the above, the method for synthesizing images captured by the first camera and the second camera has been described. In this manner, in an embodiment of the present disclosure, the different images having different angles of view may be synthesized in various manners to generate a synthetic image.

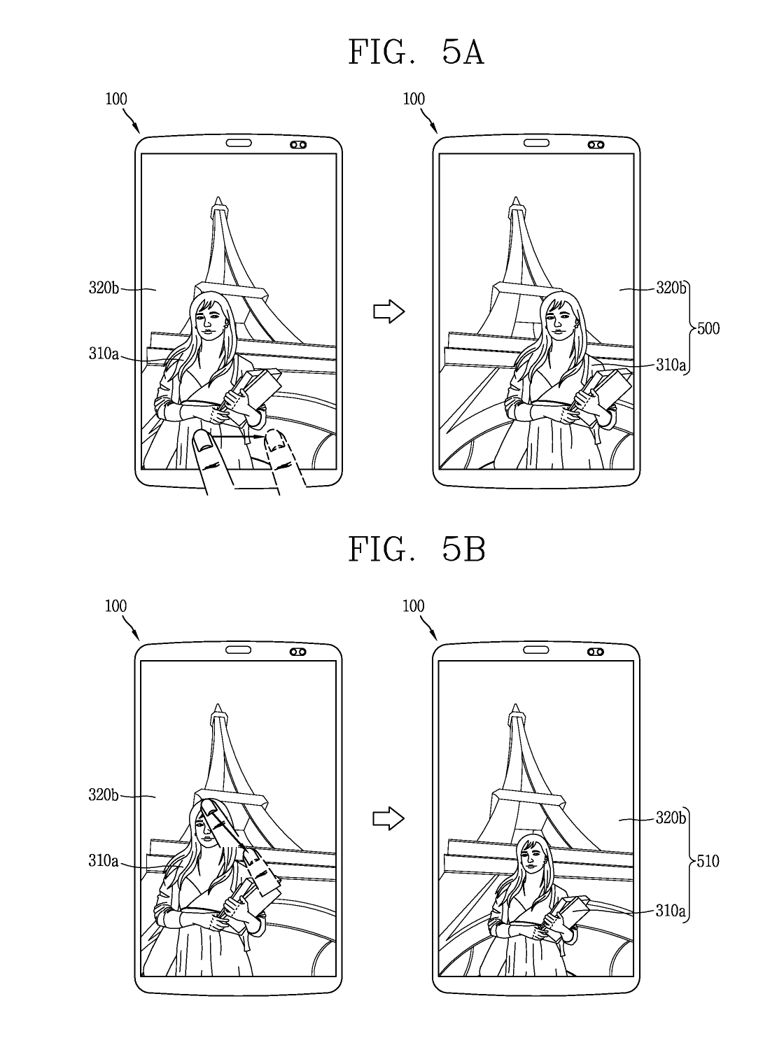

Hereinafter, a method for synthesizing a first image and a second image on the basis of a user setting will be described. FIGS. 5A and 5B are conceptual views illustrating a method for synthesizing a first image and a second image on the basis of a user setting.

The mobile terminal according to an embodiment of the present disclosure may capture a first image and a second image having different angles of view in the same image capture direction by using the first camera 221a and the second camera 221b formed to capture images at different angles of view.

The control unit 180 may synthesize the captured first image and the captured second image to generate a single synthetic image. In a case in which the first image and the second image are synthesized, the control unit 180 may set a position in which the first image is to be synthesized in the second image or a size of the first image to be synthesized on the basis of a control command of the user.

In detail, in order to determine a position of the second image in which at least a portion of the first image is to be synthesized, the control unit 180 may sense a preset type of touch applied to at least portion of the first image. For example, as illustrated in the first drawing of FIG. 5A, in a state in which the fourth partial image 320b of the second image is displayed on the display unit 151, the control unit 180 may sense a drag touch applied to the first partial image 310a of the first image.

In this case, on the basis of the preset type of touch, the control unit 180 may determine a position in the fourth partial image 320b of the second image in which the first partial image 310a of the first image is to be synthesized. For example, as illustrated in the second drawing of FIG. 5A, the control unit 180 may determine a region in which the sensing of the drag touch is terminated in the region in which the four partial image 320b of the second image is displayed, as a position in which the first partial image 310a of the first image is to be synthesized.

Thereafter, the control unit 180 may synthesize the at least portion 310a of the first image and the fourth partial image 320b of the second image in the determined position to generate a synthetic image 500.

Also, in order to synthesize the first image and the second image, the control unit 180 may set a size of the first image to be synthesized with the second image on the basis of a user request. For example, as illustrated in the first drawing of FIG. 5B, the control unit 180 may sense a touch applied to a boundary region of the first partial image 310a in the first image. On the basis of the touch applied to the first partial image 310a, the control unit 180 may change an output size of the first partial image 310a. For example, as illustrated in the second drawing of FIG. 5B, on the basis of a touch applied to the first partial image 310a, the control unit 180 may change the first partial image 310a such that an output size thereof is reduced. Thereafter, the control unit 180 may synthesize the first partial image 310a having a reduced size and the fourth partial image 320b of the second image to generate a synthetic image 510.

In the above, the method for synthesizing the first image and the second image on the basis of a control command of the user has been described. In this manner, in an embodiment of the present disclosure, the user may directly determine a form of a synthetic image.

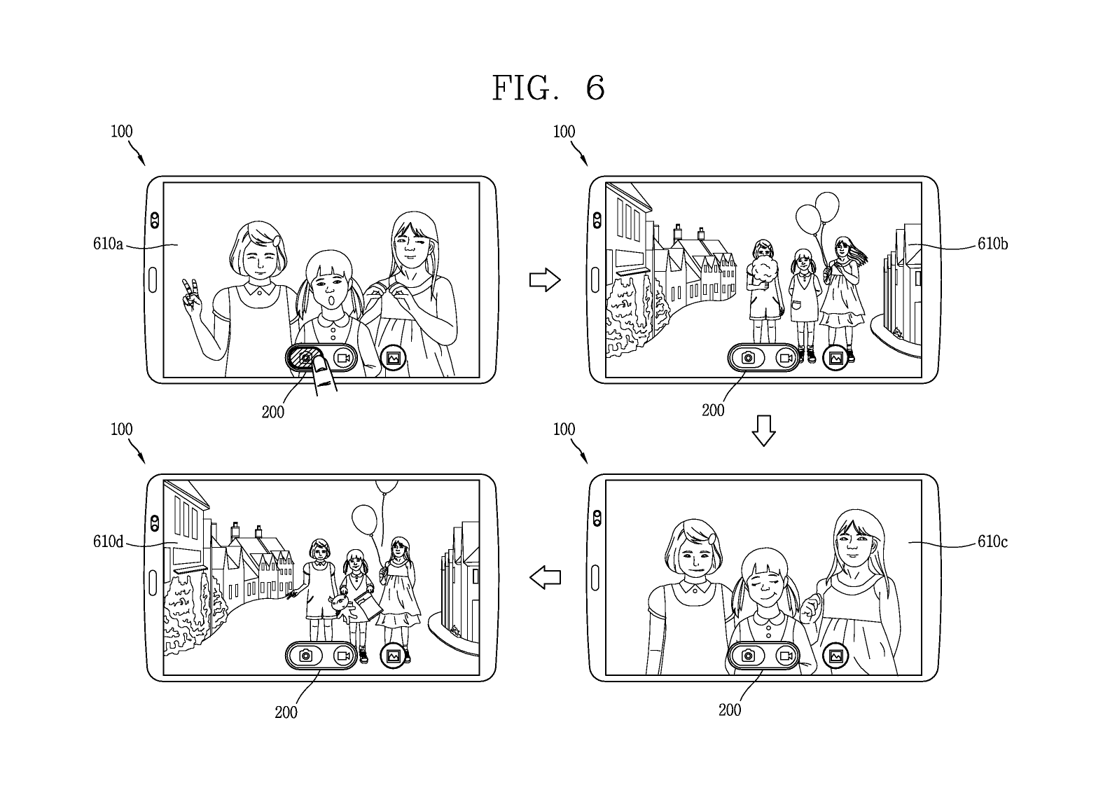

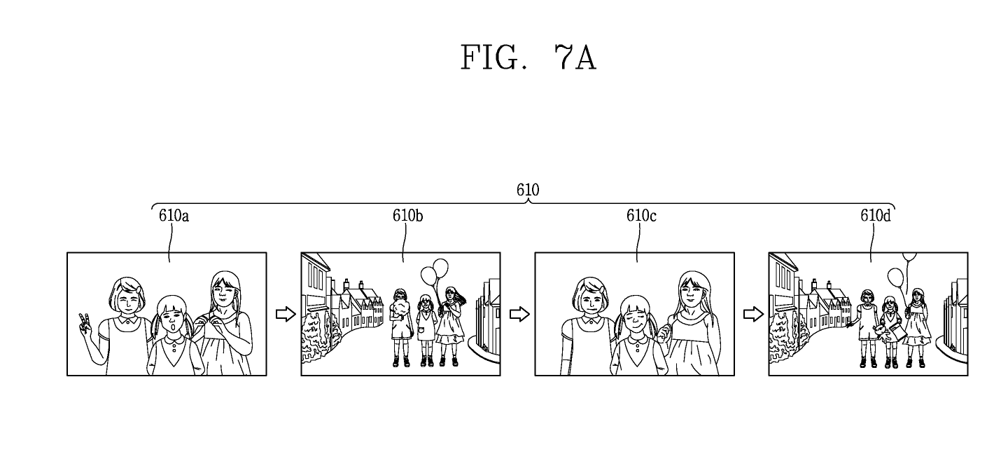

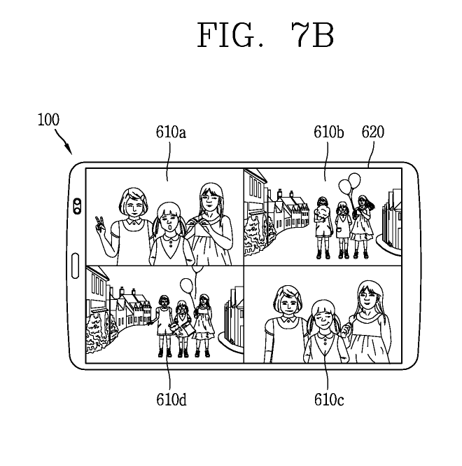

Hereinafter, a method for sequentially capturing images through the first camera and the second camera and synthesizing the captured images will be described. FIGS. 6, 7A, and 7B are conceptual views illustrating a method for sequentially capturing images through a first camera and a second camera and synthesizing the captured images.

The mobile terminal according to an embodiment of the present disclosure may sequentially capture images through the first camera 221a and the second camera 221b which are disposed on the front surface of the terminal body and capture different angles of view.

In detail, the control unit 180 may sequentially capture images through the first camera 221a and the second camera 221b according to preset order. The preset order may be set by the user or by the control unit 180.

For example, as illustrated in FIG. 6, the control unit 180 may capture a first image 610a, a second image 610b, a third image 610c, and a fourth image 610d according to order of the first camera 221a, the second camera 221b, the first camera 221a, and the second camera 221b.

In a case in which a plurality of images are captured according to the preset order, the control unit 180 may synthesize the plurality of images to generate a synthetic image. Here, the control unit 180 may generate the synthetic image on the basis of various synthesizing methods.

For example, as illustrated in FIG. 7A, the control unit 180 may generate a GIF image 610 by using the plurality of images 610a, 610b, 610c, and 610d.

In another example, as illustrated in FIG. 7B, the control unit 180 may generate a single synthetic image 620 including the plurality of images 610a, 610b, 610c, and 610d as partial images.

When the synthetic image is generated, the control unit 180 may store the generated synthetic image in the memory 170. Also, the control unit 180 may display the generated synthetic image on the display unit 151.

Also, although not shown, the plurality of images 610a, 610b, 610c, and 610d may be stored in the memory as separate images.

In the above, the method for sequentially capturing images through at least two cameras having different angles of view and synthesizing the captured images to obtain a synthesis image. In this manner, in an embedment of the present disclosure, a plurality of images having different angles of view and in the same image capture direction may be obtained. Also, the present disclosure may provide a plurality of images separately or synthesize the plurality of images to provide a synthetic image. Thus, the user may be provided with images captured through various cameras simultaneously. Also, the user may be provided with images having different angles of view without having to operate the cameras separately.

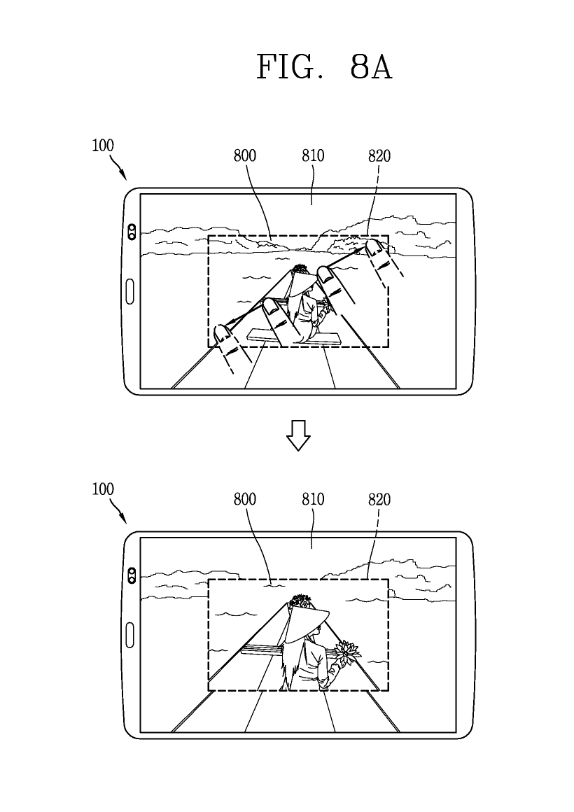

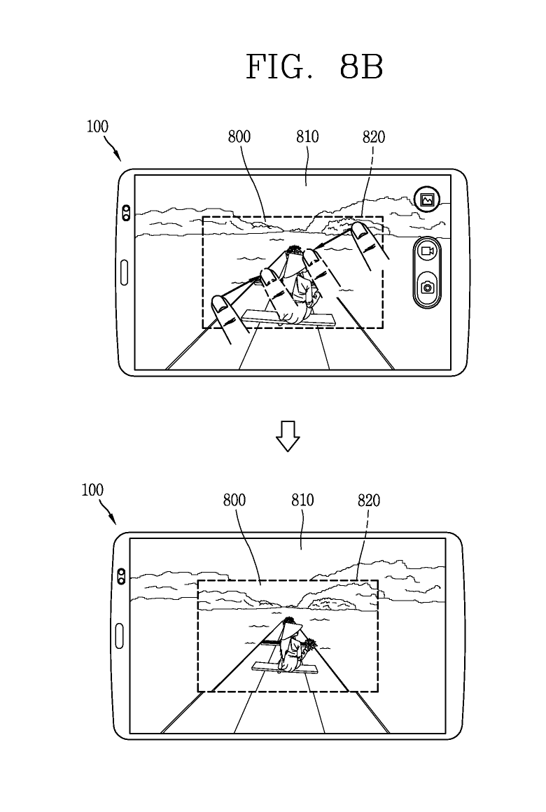

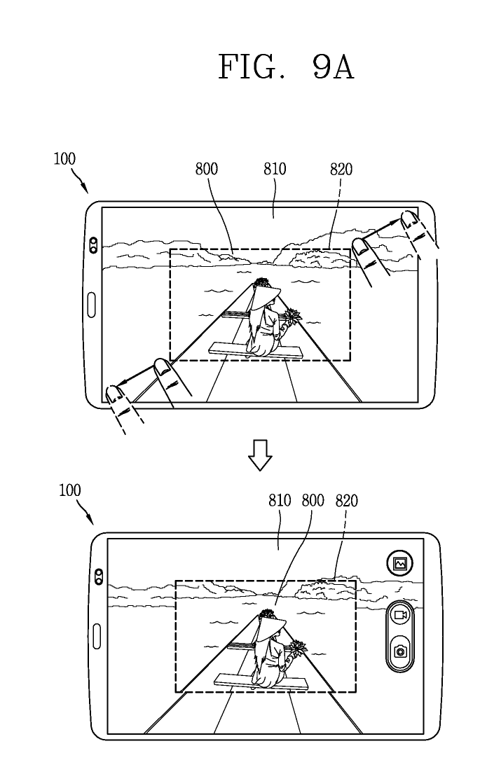

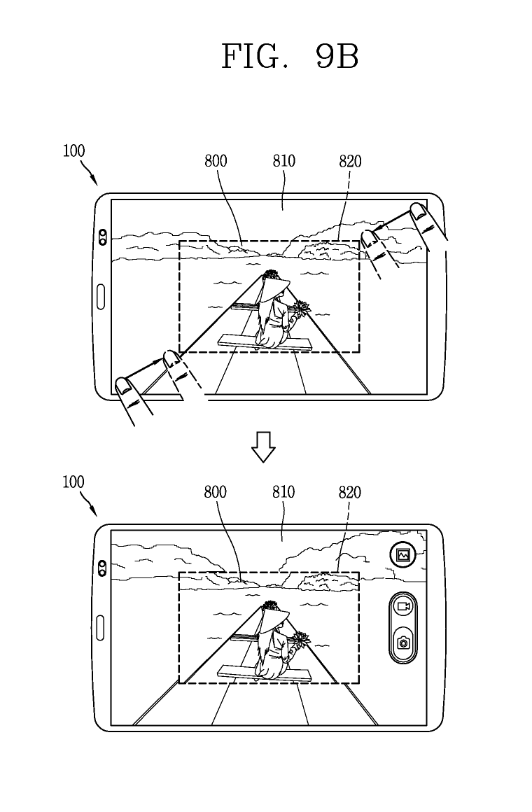

Hereinafter, a method for capturing images simultaneously through the first camera and the second camera having different angles of view and synthesizing the captured images to generate a synthetic image will be described. FIGS. 8A, 8B, 9A, and 9B are conceptual views illustrating a method for capturing images through a first camera and a second camera having different angles of view and synthesizing the images to generate a synthesized image.

The mobile terminal according to an embodiment of the present disclosure may capture a first image and a second image at different angles of view through the first camera 221a and the second camera 221b formed to capture images at different angles of view.

In order to capture the first image and the second image, the control unit 180 may display preview images of the images received from the first camera 221a and the second camera 221b together on the display unit 151.

Meanwhile, since the first camera 221a and the second camera 221b have different angles of view and receive images in the same image capture direction, images in which at least portions thereof are the same may be simultaneously received. In this case, the control unit 180 may display the first image received from the first camera 221a in a region overlapping a region in which the second image received from the second camera 221b having a greater angle of view, among the first camera 221a and the second camera 221b is displayed. That is, the control unit 180 may detect the same region as that of the first image from the second image received from the second camera 221b, and display the first image on the detected same region in an overlapping manner.

In this case, the control unit 180 may further display a graphic object for visually differentiating the first image and the second image on the preview images of the first image and the second image.

For example, as illustrated in the first drawing of FIG. 8A, the control unit 180 may display a first region 800 in which a preview image of the first image is displayed and a second region 810 in which a preview image of the second image is displayed on the display unit. Also, the control unit 180 may display the dotted line 820 for visually distinguishing between the first image and the second image on a boundary region between the first region 800 and the second region 810. Thus, the user may simultaneously view the image received from the first camera 221a and the image received from the second camera 221b. Also, the user may recognize the images received from the cameras by intuition through the graphic objects visually distinguishing between the images received from the first camera 221a and the second camera 221b.

Also, the control unit 180 may separately control the images received from the first camera 221a and the second camera 221b. In detail, on the basis of different touches applied to the first region 800 in which the preview image of the first image received from the first camera 221a is displayed, the control unit 180 may perform different controlling on the first image. In this case, the control unit 180 may not control the second image irrespective of controlling the first image.

Also, on the basis of different touches applied to the second region 810 in which the preview image of the second image received from the second camera 221b is displayed, the control unit 180 may perform different controlling on the second image. In this case, the control unit 180 may not control the first image irrespective of controlling the second image.

The different controlling may refer to performing different functions related to the images. The different functions related to the images may include a zoom-in or zoom-out function, a digital zoom-in or zoom-out function, and the like.

For example, as illustrated in FIG. 8A, when a pinch-out touch is applied to the first region 800 in which the preview image of the first image received from the first camera 221a is displayed, the control unit 180 may execute an optical zoom-in function on the first camera 221a. In this case, the preview image of the second image may not be magnified and the same preview image as that prior to the execution of the optical zoom-in function may be displayed in the second region 810.

Conversely, as illustrated in FIG. 8B, when a pinch-in touch is applied to the first region 800 in which the preview image of the first image received from the first camera 221a is displayed, the control unit 180 may execute an optical zoom-out function on the first camera 221a. In this case, the preview image of the first image reduced compared with that prior to execution of the optical zoom-out function may be displayed in the first region 800. Here, the preview image of the second image may not be reduced and the same preview image as that prior to the execution of the optical zoom-in function may be displayed in the second region 810.

In another example, as illustrated in FIG. 9A, when a pinch-out touch is applied to the second region 810 in which the preview image of the second image received from the second camera 221b is displayed, the control unit 180 may execute the optical zoom-in function on the second camera 221b. In this case, the preview image of the second image magnified compared with that prior to the execution of the optical zoom-in function may be displayed in the second region 810. Here, the preview image of the first image is not magnified and the same preview image as that prior to the execution of the optical zoom-in function may be displayed in the first region 800.

Conversely, as illustrated in FIG. 9B, when a pinch-in touch is applied to the second region 810 in which the preview image of the second image received from the second camera 221b is displayed, the control unit 180 may execute the optical zoom-out function on the second camera 221b. In this case, the preview image of the second image reduced compared with that prior to the execution of the optical zoom-out function may be displayed in the second region 810. Here, the preview image of the first image may not be reduced and the same preview image as that prior to the execution of the optical zoom-out function may be displayed in the first region 800.

In a state in which the preview image of the first image received from the first camera 221a is displayed on the region overlapping the region in which the preview image of the second image received from the second camera 221b having a greater angle of view among the first camera 221a and the second camera 221b on the display unit 151, when a request for capturing an image is received from the user, the control unit 180 may capture a synthetic image formed by synthesizing the preview image of the first image and the preview image of the second image.

For example, as illustrated in the first drawing of FIG. 8A, in a state in which the first image and the preview image of the second image displayed in an overlapping manner, when an image capture request is received, the control unit 180 may generate a synthetic image in a state in which the first image and the second image are displayed in the overlapping manner. That is, the control unit 180 may generate a synthetic image having the same form as that of the preview image displayed on the display unit 151.

Thus, as described above, in a case in which the preview image is zoomed in or zoomed out, the control unit 180 may generate a synthetic image in a zoomed-in or zoomed-out form. For example, as illustrated in the second drawing of FIG. 8A, in a case in which a preview image magnified from the first image is displayed on the preview image of the second image in an overlapping manner, the control unit 180 may generate a synthetic image in such a form that the magnified preview image of the first image and the preview image of the second image are displayed.

Also, the control unit 180 may edit the first image and the second image such that the first image and the second image have different visual effects. The visual effects may refer to a visual shape in which an image is displayed on the display unit. For example, the visual effect may be an effect of changing at least one of a color, a chroma, and brightness of an image. For example, the control unit 180 may set the first image to a black-and-white image and the second image as a colored image.

A visual effect of each image may be set by the user or may be determined by an angle of view of a camera. For example, in a case in which a camera has a first angle of view, the control unit 180 may control the camera having the first angle of view to capture a colored image, and in a case in which the camera has a second angle of view greater than the first angle of view, the control unit 180 may control the camera having the second angle of view to capture a black-and-white image.

Also, the control unit 180 may synthesize the first image and the second image having different visual effects to generate a synthetic image. For example, the control unit 180 may synthesize a first image set as a black-and-white image and a second image set as a colored image to generate a synthetic image. In this case, the synthetic image may include a partial image set to be black and white and a partial image set to be colored.

Thus, the user may view the synthetic image generated by synthesizing the first image and the second image having different visual effects. In the above, the method for simultaneously capturing images received through the cameras having different angles of view and synthesizing the captured images has been described. In this manner, in an embodiment of the present disclosure, when images are captured, the user may directly select a form of a synthetic image. In the above, the method for capturing images respectively received from the first camera and the second camera and synthesizing the captured images simultaneously to generate a synthetic image has been described.

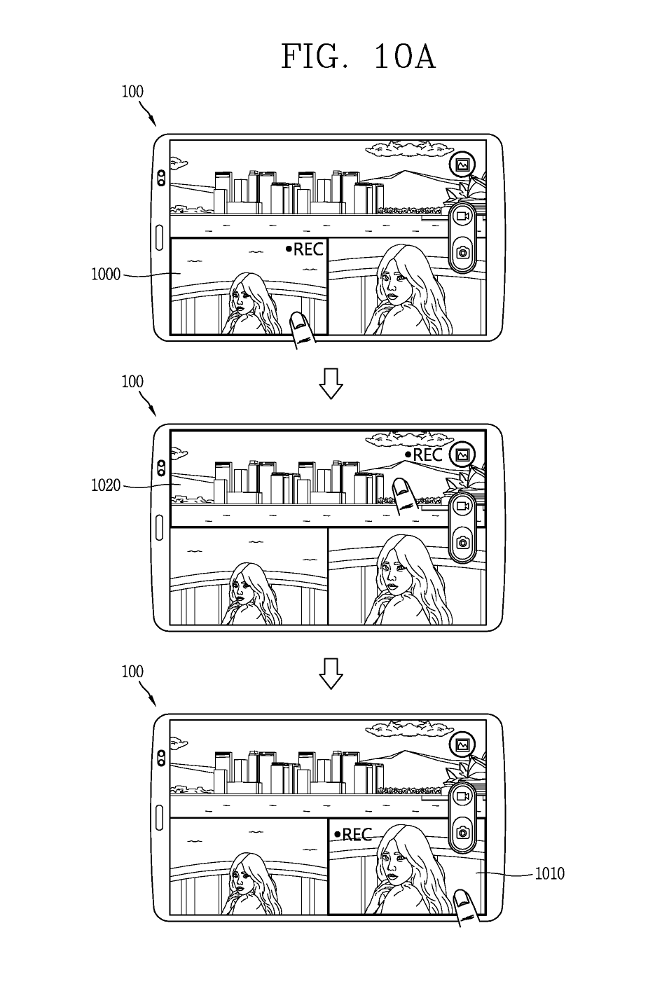

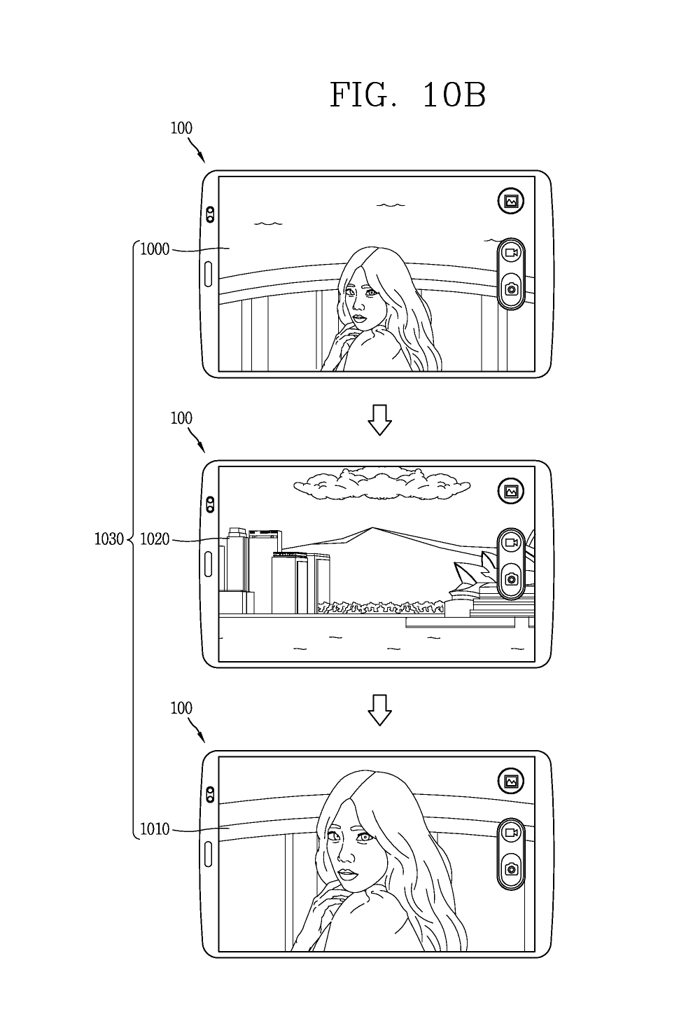

Hereinafter, a method for capturing images received through a plurality of cameras as video on the basis of a user touch will be described. FIGS. 10A and 10B are conceptual views illustrating a method for capturing video with images received through a plurality of cameras.

The mobile terminal according to an embodiment of the present disclosure may receive images through the first camera 221a and the second camera 221b which capture images at different angles of view in the same image capture direction. Also, the mobile terminal according to an embodiment of the present disclosure may further include a third camera (not shown) having a direction different from those of the first and second cameras 221a and 221b. For example, the third camera may be a camera having an image capture direction opposite to the image capture directions of the first and second cameras 221a and 221b.

The control unit 180 may display preview images of images received through the first camera 221a, the second camera 221b, and the third camera together on the display unit 151. For example, as illustrated in the first drawing of FIG. 10A, the control unit 180 may display the preview image of a first image received from the first camera 221a, the preview image of a second image received from the second camera 221b, and the preview image of a third image received from the third camera together on the display unit 151.

Also, in response to a touch applied to each of the preview images, the control unit 180 may capture an image received from any one of the first camera 221a, the second camera 221b, and the third camera, as video.

In detail, as illustrated in the first drawing of FIG. 10A, in response to a touch applied to a preview image 1000 of the second image received from the second camera 221b, the control unit 180 may capture the second image received from the second camera 221b, as video. In this case, the control unit 180 may further display a graphic object REC indicating that the second image is being captured as video.

Meanwhile, as illustrated in the second drawing of FIG. 10A, when a touch applied to a preview image 1020 of the third image received from the third camera is sensed while the second image received from the second camera 221b is being captured as video, the control unit 180 may capture the third image received through the third camera, as video. In this case, the control unit 180 may stop capturing the video of the second image received from the second camera 221b. Also, the control unit 180 may capture the third image received from the third camera, as video. That is, subsequent to the video which has been captured until the touch is applied to the preview image 1020 of the third image, the control unit 180 may capture the third image received from the third camera, as video. That is, in an embodiment of the present disclosure, images received from the respective cameras may not be captured as separate video but the image received through the different cameras may be generated as single video.

Similar to the afore-mentioned, when a touch applied to the preview image 1010 of the first image received from the first camera is sensed, the control unit 180 may capture the first image received through the first camera, as video. In this case, the control unit 180 may stop capturing video of the third image received through the third camera. Also, subsequent to the video which has been captured until the touch is applied to the preview image 1010 of the first image, the control unit 180 may capture the first image received from the first camera 221a, as video.

That is, as illustrated in FIG. 10B, the control unit 180 may generate videos sequentially captured in order of the second camera 221b, the third camera, and the first camera 221a, as single video 1030. Thus, the user may conveniently capture video having various angles of view and various image capture directions.

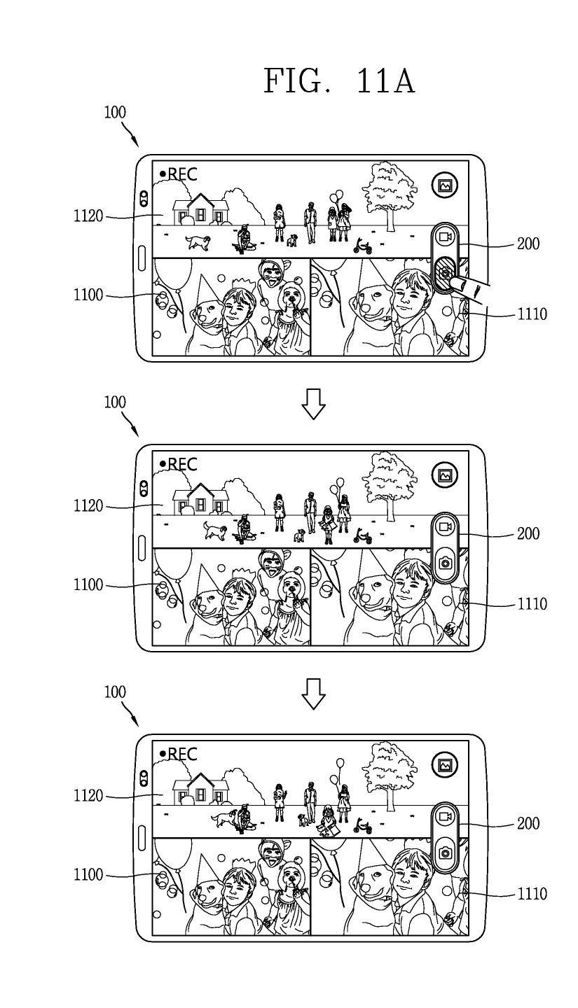

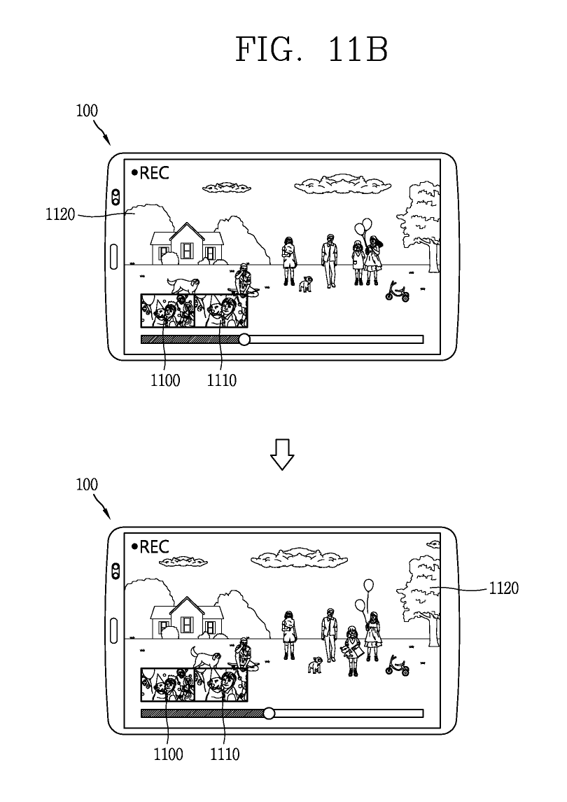

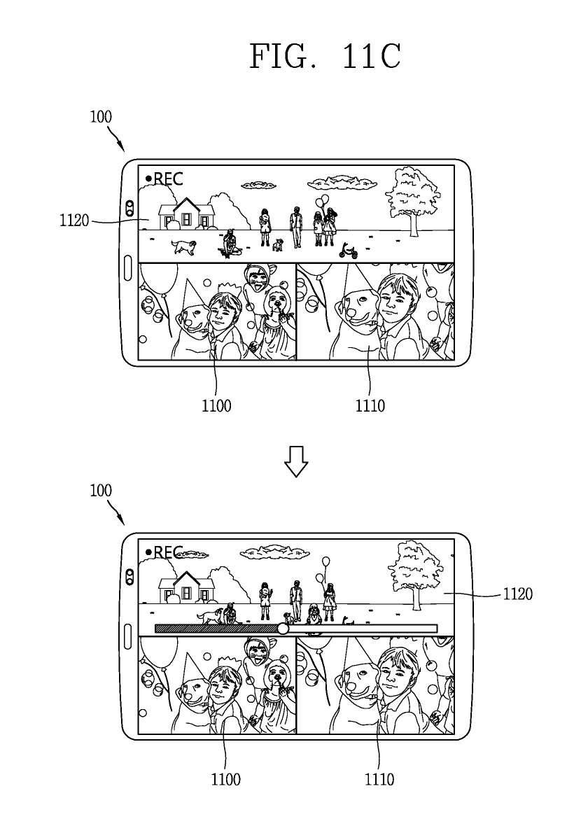

Hereinafter, a method for capturing video and a still image together through a plurality of cameras will be described. FIGS. 11A, 11B, and 11C are conceptual views illustrating a method for capturing video and a still image through a plurality of cameras.

The mobile terminal according to an embodiment of the present disclosure may receive images through the first camera 221a and the second camera 221b which capture images at different angles of view in the same image capture direction. Also, the mobile terminal according to an embodiment of the present disclosure may further include the third camera (not shown) having an image capture direction different from those of the first and second cameras 221a and 221b. For example, the third camera may be a camera having an image capture direction opposite to the image capture directions of the first and second cameras 221a and 221b.

The control unit 180 may capture images received through the first camera 221a, the second camera 221b, and the third camera, as one of still images or video. For example, the control unit 180 may capture the first image and the second image received from the first camera 221a and the second camera 221b as still images, and the third image received from the third camera as video.

Here, in response to a touch applied to a graphic object associated with an image capture request function, the control unit 180 may capture the images received from the first camera 221a, the second camera 221b, and the third camera simultaneously. For example, as illustrated in the first drawing of FIG. 11A, in response to a touch applied to a graphic object 200 associated with the image capture request function, the control unit 180 may capture a first image 1110 and a second image 1100 respectively received from the first camera 221a and the second camera 221b as still images, and capture a third image 1120 received from the third camera as video.

While the video is being captured, when a touch is applied to the graphic object 200 associated with the image capture request function, the control unit 180 may stop capturing the video and may generate the captured image as video.

Also, the control unit 180 may process the captured images in an associated manner. In detail, the control unit 180 may synthesize the first image 1110, the second image 1100, and the third image 1120 to generate a synthetic image.

The synthetic image may be an image in which the still images are displayed together while video is being reproduced (or played). For example, as illustrated in FIG. 11B, while the third image is being reproduced, the control unit 180 may display thumbnail images of the first image 1110 and the second image 1100 on the third image in an overlapping manner. Alternatively, as illustrated in FIG. 11C, the control unit 180 may divide the display unit 151 into a display region of the third image 120, a display region of the first image 1110, and a display region of the second image 1100, and display the first image 1110, the second image 1100, and the third image 1120 in the respective regions.

In this manner, in an embodiment of the present disclosure, image capturing may be performed at various moments simultaneously, at various angles and in various image capture directions.

In an embodiment of the present disclosure, various images may be captured through at least two cameras having different angles of view.

Also, in an embodiment of the present disclosure, image capturing may be performed with at least two cameras having different angels of view, and a synthetic image may be generated by using images captured by respective cameras. Thus, in an embodiment of the present disclosure, images at moments may be captured at various angles of view and in various image capture directions and stored.

The present invention described above may be implemented as a computer-readable code in a medium in which a program is recorded. The computer-readable medium includes any type of recording device in which data that can be read by a computer system is stored. The computer-readable medium may be, for example, a hard disk drive (HDD), a solid state disk (SSD), a silicon disk drive (SDD), a ROM, a RAM, a CD-ROM, a magnetic tape, a floppy disk, an optical data storage device, and the like. The computer-readable medium also includes implementations in the form of carrier waves (e.g., transmission via the Internet). Also, the computer may include the control unit 180 of the terminal. Thus, the foregoing detailed description should not be interpreted limitedly in every aspect and should be considered to be illustrative. The scope of the present invention should be determined by reasonable interpretations of the attached claims and every modification within the equivalent range are included in the scope of the present invention.

The foregoing embodiments and advantages are merely exemplary and are not to be considered as limiting the present disclosure. The present teachings can be readily applied to other types of apparatuses. This description is intended to be illustrative, and not to limit the scope of the claims. Many alternatives, modifications, and variations will be apparent to those skilled in the art. The features, structures, methods, and other characteristics of the exemplary embodiments described herein may be combined in various ways to obtain additional and/or alternative exemplary embodiments.

As the present features may be embodied in several forms without departing from the characteristics thereof, it should also be understood that the above-described embodiments are not limited by any of the details of the foregoing description, unless otherwise specified, but rather should be considered broadly within its scope as defined in the appended claims, and therefore all changes and modifications that fall within the metes and bounds of the claims, or equivalents of such metes and bounds are therefore intended to be embraced by the appended claims.

What is claimed is:

1. A mobile terminal comprising:
a first camera configured to capture an image at a first angle of view;
a second camera configured to capture an image at a second angle of view that is different from the first angle of view; and
a controller configured to:
capture a first image received from the first camera and a second image received from the second camera; and
process the first image and the second image by associating the first image with the second image.

2. The mobile terminal of claim 1, wherein the controller is further configured to:
detect a partial image corresponding to the first image in the second image; and
replace the detected partial image with at least a portion of the first image to generate a synthetic image including the at least portion of the first image and a portion of the second image.

3. The mobile terminal of claim 1, wherein the first camera and the second camera are directed to a same image capture direction, and the controller is further configured to capture the first image and the second image simultaneously in the same image capture direction.

4. The mobile terminal of claim 3, wherein the controller is further configured to generate at least one of the simultaneously captured images as a moving image or video.

5. The mobile terminal of claim 1, wherein the controller is further configured to capture the first image received via the first camera and the second image received via the second camera sequentially in a set order.

6. The mobile terminal of claim 1, further comprising:
a display,
wherein the controller is further configured to cause the display to display a first preview image of the first image and a second preview image of the second image in an overlapping manner such that the first preview image is displayed within a region of the second preview image.

7. The mobile terminal of claim 6, wherein the controller is further configured to cause the display to display a boundary of the region of the second preview image within which the first preview image is displayed.

8. The mobile terminal of claim 6, wherein the controller is further configured to control the first camera or the second camera such that the first preview image or the second preview image is zoomed in or zoomed out when a touch is applied to the display on which the first preview image and the second preview image are displayed.

9. The mobile terminal of claim 6, wherein the controller is further configured to control the first camera or the second camera, causing the first image and the second image to have different visual effects.

10. The mobile terminal of claim 6, wherein the controller is further configured to capture the first image and the second image simultaneously, synthesize the first image and the second image such that the first image overlaps the second image, and generate a synthetic image including the overlapping images in response to a user input for capturing an image.

11. The mobile terminal of claim 1, further comprising:
a display,
wherein the controller is further configured to:
cause the display to divide a display region into a first region displaying a first preview image of the first image and a second region displaying a second preview image of the second image; and
capture the first image as video when a touch is applied to the first region while the first preview image is displayed on the first region and the second preview image is displayed on the second region.

12. The mobile terminal of claim 11, wherein the controller is further configured to capture the second image as video when a touch is applied to the second region while the first image is being captured as the video.

13. The mobile terminal of claim 12, wherein the controller is further configured to stop the capturing of the first image as the video when the touch is applied to the second region while the first image is being captures as the video.

14. The mobile terminal of claim 12, wherein the controller is further configured to synthesize the first image captured as the video and the second image captured as the video to generate a synthetic image.

15. The mobile terminal of claim 1, further comprising:
a third camera directed to an image capture direction that is different from a same image capture direction of the first camera and the second camera,
wherein the control unit is further configured to:
capture the first image received via the first camera and the second image received via the second camera as still images; and
capture an image received via the third camera as video.

16. A method for controlling a mobile terminal having first and second cameras, the method comprising:
capturing a first image received from the first camera configured to capture an image at a first angle of view;
capturing a second image received from the second camera configured to capture an image at a second angle of view that is different from the first angle of view; and
processing the first image and the second image by associating the first image with the second image.

17. The method of claim 16, wherein the processing the first image and the second image comprises generating a synthetic image by synthesizing at least a portion of the first image and at least a portion of the second image.

18. The method of claim 17, wherein the synthetic image is generated by replacing a partial image corresponding to the first image and included in the second image with the at least portion of the first image such that the generated synthetic image includes the at least portion of the first image and the at least portion of the second image.

19. The method of claim 16, further comprising:
displaying a first preview image of the first image and a second preview image of the second image on a display; and
zooming in or zooming out the first preview image or the second preview image when a touch is applied to a region of the display in which the first preview image or the second preview image is displayed.

20. The method of claim 19, further comprising displaying the first preview image and the second preview image in an overlapping manner such that the first preview image is displayed within a region of the second preview image.
